(19) United States
(12) Patent Application Publication
(10) Pub. No.: US 2025/0168002 A1
(43) Pub. Date: May 22, 2025

(54) SYSTEM FOR CREATING, MANAGING, STORING, AND UTILIZING VERIFIED DIGITAL TOKENS HAVING LIMITED DATA PUBLICATION

(71) Applicant: Scientia Potentia Est II, LLC, Charleston, SC (US)

(72) Inventors: Jeremy Blackburn, Charleston, SC (US); W. Kurt Taylor, N. Charleston, SC (US); Karl David, Charleston, SC (US); Austi Critchfield, Clearwater, FL (US); Michael Lu, N. Charleston, SC (US); Tim McVicker, Charleston, SC (US); Bryan McArdle, Charleston, SC (US)

(73) Assignee: Scientia Potentia Est II, LLC, Charleston, SC (US)

(21) Appl. No.: 18/652,588

(22) Filed: May 1, 2024

Related U.S. Application Data
(63) Continuation-in-part of application No. 17/697,839, filed on Mar. 17, 2022, now abandoned.
Application No. 17/697,839 is a continuation-in-part of application No. 17/686,502, filed on Mar. 4, 2022, now Pat. No. 11,610,202.
Application No. 17/686,502 is a continuation-in-part of application No. 17/566,957, filed on Dec. 31, 2021.
Application No. 17/566,957 is a continuation-in-part of application No. 17/561,827, filed on Dec. 24, 2021, now Pat. No. 11,574,319.
Application No. 17/561,827 is a continuation-in-part of application No. 17/531,746, filed on Nov. 20, 2021, now Pat. No. 11,482,325.
Application No. 17/531,746 is a continuation-in-part of application No. 17/531,598, filed on Nov. 19, 2021, now abandoned.
Application No. 17/531,598 is a continuation-in-part of application No. 17/344,043, filed on Jun. 10, 2021, now abandoned.
Application No. 17/344,043 is a continuation-in-part of application No. 17/230,911, filed on Apr. 14, 2021, now Pat. No. 11,288,761.
Application No. 17/230,911 is a continuation-in-part of application No. 17/176,056, filed on Feb. 15, 2021, now Pat. No. 11,288,308.
Application No. 17/176,056 is a continuation-in-part of application No. 17/128,084, filed on Dec. 19, 2020, now Pat. No. 11,521,157.
Application No. 17/128,084 is a continuation-in-part of application No. 16/997,840, filed on Aug. 19, 2020, now Pat. No. 11,449,949.
Application No. 16/997,840 is a continuation-in-part of application No. 16/994,585, filed on Aug. 15, 2020, now Pat. No. 11,232,652.
Application No. 16/994,585 is a continuation-in-part of application No. 16/991,916, filed on Aug. 12, 2020, now Pat. No. 11,216,823.
Application No. 16/991,916 is a continuation-in-part of application No. 16/876,080, filed on May 17, 2020, now Pat. No. 11,423,360.
Application No. 16/876,080 is a continuation-in-part of application No. 16/810,782, filed on Mar. 5, 2020, now Pat. No. 11,216,781.
Application No. 16/810,782 is a continuation-in-part of application No. 16/510,634, filed on Jul. 12, 2019, now Pat. No. 10,713,737.
Application No. 16/510,634 is a continuation-in-part of application No. 16/452,076, filed on Jun. 25, 2019, now abandoned.
Application No. 16/810,782 is a continuation-in-part of application No. 16/510,642, filed on Jul. 12, 2019, now Pat. No. 11,216,772.
Application No. 16/510,642 is a continuation-in-part of application No. 16/452,076, filed on Jun. 25, 2019, now abandoned.
(60) Provisional application No. 63/622,366, filed on Jan. 18, 2024.
(60) Provisional application No. 63/499,728, filed on May 3, 2023.
(60) Provisional application No. 63/499,659, filed on May 2, 2023.
(60) Provisional application No. 63/463,481, filed on May 2, 2023.

(51) Int. Cl. H04L 9/32

(52) U.S. Cl. CPC H04L 9/3213; H04L 9/3231

(57) ABSTRACT

The present system can include the ability to create and store a unique digital identity of an individual. The system can include an generation server and an immutable storage system. An identity capture device can be adapted to: receive a first biometric information from the identity capture device, create a digital identity record according to the first biometric information, store the digital identity record on the immutable storage system, create a digital envoy according to the digital identity record wherein the digital envoy is uniquely associated with the digital identity record, wherein the digital envoy is adapted to be provided to an authentication system wherein the authentication system is adapted to receive a second biometric information, receive the digital envoy, retrieve the digital identity record, and create an authentication approval according to a positive comparison of the digital identity record and the second biometric information.

### BACKGROUND

### 1) Field of The System

A system for creating and storing verified digital identities and associating credentials using immutable records verified with third party system that can include verification with one or more individuals, events, accomplishments, and activities including using governmental identification issuance, storage, and verification systems wherein the digital identities can be authenticated.

### 2) Background

In many areas, confidence that the identity of an individual is as that individual represents is advantageous, if not critical. Through activity, time and events, trust can develop between a company and its customers, employers and employees, companies and independent contractors, citizens and their government and the like. For example, a longtime customer of a business may not be subject to credit terms while a new customer may be required to provide deposits, down payments, letters of credit and the like. Further, when accessing sensitive information and accounts, identification verification can be important if not critical. For example, when accessing a bank account, traveling, interacting with law enforcement or government systems, voting, using credit cards, and the like, verification that the individual is who they say they are is critical to avoiding mistake and even fraud. Traditionally, this identification verification is performed with a “picture ID” such as a driver's license, identification card, passport, and the like.

However, these forms of identification expose personal information to the public which can increase the risk of identity theft. Referring to FIGS. 1A and 1B (prior art) a state or federal issued identification 100 can include name 102, address 104, military service 106, birth date 108, issue date 110, gender 112 eye color 114, height 116, signature 118, state of issue 120, facial image 122 and place of birth 124.

The use of these forms of identification has become increasingly risky given that thieves have become accomplished at changing the photo in a passport or driver's license and using the information to create fraudulent identifications which can be used for improper financial gain, access to certain information and even commit crimes. Information that is contained on these forms of identification can be all that is needed for a thief to commit such illegal acts. The damage to the true individual associated with the identification card can include a thief creating credit cards and credit accounts and abusing these, accessing financial accounts, obtain medical treatment making the true holder of the identity liable for the bills, providing false information when arrested, stealing income tax returns and the like. In certain cases, the true identity holder may be forced to change the entire identity including receiving a new Social Security number and replace all accounts. Therefore, a system that provides for accurate verified identification without the release of personal information to the public is a system that is much needed, especially with modern technology and identification practices.

The risks with physical identification bearing personal information has increased as technology advances. One such increase in risk is with the increased use of digital identification for online activity including financial transactions, commerce (e.g., online shopping) and travel.

Generally, a digital identity is an online or digital representation of a person's identity. In some implementations, it can include personal information that can be used to identify an individual, such as their name, address, date of birth, social security number, account information, etc. Typically, this information is stored in databases and can be retrieved by anyone with the proper credentials. For example, states require drivers to provide personal data to obtain a driver's license or identification card and to register a vehicle. Typically, this information is stored on state-controlled databases and can include records associated with arrests, traffic offenses, accidents and other personal information beyond that of just the identification information. In operation, these databases are accessible by many entities including with the only protections being what the state puts in place and existing federal and state laws and rules outlining the circumstances in which this data can be accessed and used. Unfortunately, using laws and rules is a deterrent that punishes activity after the data has been improperly accessed or used. These laws have proven to be ineffective. In one state, 25,000 spot-checks were made and only one instance resulted in sufficient evidence of improper activity to ban that user from accessing the database in the future. The same states reports that no fines or lawsuits were ever instigated for improper access. Further, the same state reported multiple instances of users improperly accessing department of motor vehicles (DMV) records to “spy” on ex-boyfriends, women that the user wished to date, and parties to legal battles-all improper uses.

In another state, an audit resulted in 11,000 police officers who accessed the motor-vehicle databases and conclude that about half of the access activity appeared questionable. A female former police officer who found she had been looked up more than 500 times. Personal information and a photograph of a television anchorwoman were accessed 1,400 times. In one state, over 125,000 audit letters were sent requesting that the user explain the access to the DMV records. Generally, there was no effort to verify the truthfulness of the response. As can be seen, the reliance upon rules and procedures to prevent access to personal information is inadequate and much attention needs to be placed on the ability to have secure digital identification access that cannot be improperly access, used or disclosed.

Another risk with digital identifications is that some verification services require that identification cards such as driver's licenses and social security cards be scanned and uploaded in order to participate in online digital identification card services. Some services use the online digital identification card for shopping, ordering prescription drugs, applying for jobs, and accessing governmental services (e.g., Internal Revenue Services, Social Security Administration, and state Departments of Labor). There are risks with these systems that include the upload process being subject to snooping attacks where intruders can listen to digital traffic (e.g., the uploads) between the identity holder and the online services.

It would be advantageous to have a system that allowed the holder of the digital identity to control when and for what purpose the digital identity is used.

With the increasing use of online services, all industries face risk and compliance challenges both with authentication of digital information as well as authentication of such digital information. This is especially true with the increased use of digital identities for facilitating paperless transactions, accessing financial institution systems, recording property ownership records, dealing with crypto-currencies, digital art, and NFTs, and the like. Development in digital technologies includes smart contracts which are tools that can automatically execute transactions if certain conditions are met without requiring the help of an intermediary company or entity can benefit for secure digital identities. Smart contracts are associated with blockchain technology where the smart contract and its execution can be written to a blockchain platform.

Blockchain technologies that are designed to allow for distributed storage is data without modification to the data are being used for cryptocurrency to increase security reduce risk in alteration of the data as well as to provide for tokens including non-fungible tokens (NFT).

When it comes to digital identities, previous systems use physical objects (e.g., identification such as driver's license and passports) in an attempt to “digitize” the identification. Historically, this attempt is digitization focused on creating a digital scan of the physical object so that the digital information can be manipulated by information systems and stored on a database. These systems expose personal information to the public, unnecessarily.

Proper digitization involves the digital information representing the physical object with authentication and verification. The current state of the art only includes electronic scanning of physical assets which is not authentication or verification of identity. Electronic scanning simply creates a digital copy that is separate from the physical object and becomes an independent object itself. As such, there is a lack of confidence that the individual presenting an identification (e.g., driver's license) is presenting a valid and authentic identification. One need only look at the “fake ID” market to see that this is an area that needs much attention. On study estimated that the “fake ID” market would grow to $15-20 billion in 2022. One attempts to prevent these improper actions is shown in U.S. Pat. No. 11,558,377 which, disadvantageously, exposes personal information to the public and transmits personal information over networks which may or may not have proper security.

Improvements to the current technology that exposes personal information each time identification is requested is much needed. Further, the ability to verify identification information without needing to access a governmental system each time identification needs to be verified is needed.

### SUMMARY OF THE SYSTEM

The ability to securely and properly verify an identity using a digital representation without exposing personal information is needed. This system can provide improved functionality to computerized systems by, amoung other things, allowing the verification and authentication of a digital identity without the exposure of personal information. Further, the system can provide for the verification and authentication of a digital identity without the need to access a governmental verification system each time the identity needs to be verified. Further, the system improves computerized system by immutable storing tokens that are associated with verified identities allowing the token to serve as part of the verified and authentic identification process. Further the system provides for live biometric confirmation of the token and thus the government ID. Further, the system improves computerized systems by allowing the user to control the presentation of the token without having to provide personal information each time identification is requested. This system also improves the technology and technical field of identification verification and authentication by increasing efficiency, protecting personal information, and placing access to verification and authentication in the hands of the user rather than publicly exposing personal information from identification documents (e.g., driver's licenses and passports) when identification is required.

The system can be for creating and storing a unique digital identity associated with an individual comprising: a first capture device adapted to capture biometric information, alpha numeric information and graphical information; an generation server in communications with the first capture device and an immutable storage system; a generation server adapted to generate the VDT from an individual envoy representing a digital representation of an individual data captured from the first capture device and wherein the VDT is verified from a verification system; a verification system having a set of verified identity records and in communication with the generation server wherein the set of verified identity records include personal information; wherein the generation server is adapted to: receive a first biometric information from the first capture device, receive identification information from the first capture device, transmit the first biometric information and the identification information to the verification system, receive an individual verification determination from the verification system, associate the first biometric information with the individual verification determination, create a digital identity record according to the first biometric information and an affirmative individual verification determination, and, store the digital identity record on the immutable storage system, create a digital envoy according to the digital identity record wherein the digital envoy is uniquely associated with the digital identity record; and, an authentication system adapted to: receive the digital envoy, receive a second biometric information, retrieve the digital identity record from the immutable storage system according to the digital envoy, and, create an authentication information determination according to a comparison of the digital identity record and the second biometric information wherein the authentication information determination can include a status of authentication and not authenticated.

The personal information can be inaccessible to the generation server. The first capture device can be a mobile computing device. The verification system can be taken from the group consisting of a government verification system, a witness verification system, an organization verification system, an aggregate of one or more events, a self-verification system, an in-person verification system and any combination thereof. The identity recording system, verification system and authentication systems can be autonomous computing systems. The generation server can be adapted to create a confident value associated with the digital identity record and according to the verification system. The generation server can be adapted to create a confident value associated with the digital identity record and according to a comparison of a location, a time, an object, an event and any combination thereof associated with the individual. The digital envoy can be stored in a digital wallet. The individual verification can be represented by a binary response. The digital envoy can be taken from the group consisting of a computer readable code, an alpha numeric code, a bar code, a quick response code and any combination thereof.

The can include an generation server in communications with an immutable storage system; an identity capture device in communications with the identity recording system; wherein the generation server is adapted to: receive a first biometric information from the identity capture device, create a digital identity record according to the first biometric information, store the digital identity record on the immutable storage system, create a digital envoy according to the digital identity record wherein the digital envoy is uniquely associated with the digital identity record, wherein the digital envoy is adapted to be provided to an authentication system wherein the authentication system is adapted to receive a second biometric information, receive the digital envoy, retrieve the digital identity record, and create an authentication approval according to a positive comparison of the digital identity record and the second biometric information.

The generation server can be adapted to transmit a verification system in communication with the identity recording system, receive a verification response from the verification system and create the digital identity record according to verification response. The generation server can be adapted to transmit an identification information to a verification system in communication with the identity recording system, receive a verification response from the verification system and create the digital identity record according to verification response. The identification information can be an issued identification generated from an entity taken from the group consisting of a government, a company or an organization and any combination thereof. The generation server can be adapted to receive geographic information from the identity capture device representing a location of the identity capture device when the first biometric information is received and create the digital identity record according to the geographic information. The generation server can be adapted to receive temporal information from the identity capture device representing a date when the first biometric information is received and create the digital identity record according to the temporal information. The generation server is adapted to receive an information presentation request from the individual and provide personal information limited to the information presentation request. The generation server can be adapted to receive an information presentation request from the individual and provide authentication of an information subset limited to the information presentation request. The digital identity record can include credential information taken from the group consisting of diploma information, memberships, associations, voting information, license information, certification information, compliance information, background check, financial status, citizenship, permits, authorizations, authority, vital records, and any combination thereof. Credential information can include any information associated with the individual or organization of both representing licenses, approvals, accomplishments, authorization, skills levels, and the like.

In at least one embodiment of the present invention, the issuing system is adapted to transmit the entity formation request to a formation authority system, receive an entity formation information and create the digital representation according to the entity formation information. The formation authority system may, but need not always, be an official government system. In at least one embodiment of the present invention, the formation authority system is adapted to capture formation location information associated with the entity organizer and include the formation location information in the digital representation of the created entity. In at least one embodiment of the present invention, the formation authority system is also adapted to capture a formation authority system location associated with the formation authority system and include the formation authority system location in the digital representation of the created entity. In at least one embodiment, the formation authority system is adapted to capture biometric information of a formation individual associated with the formation authority system and to include the biometric information in the entity formation information. In some embodiments, prior to including the formation individual's biometric information as part of the entity formation information, the formation authority system transmits the formation individual's biometric information to the identity verification system 208 and to receive a formation individual verification information from the identity verification system, indicating whether the formation individual's biometric information matched the digital identity of the formation individual that is stored by the identity verification system. In such a case, the formation authority system may create the entity formation information according to the formation individual verification information so that the formation individual verification information is included as part of the entity formation information.

In at least one embodiment of the present invention, the issuing system includes an issuing system identification, and the issuing system is adapted to transmit the issuing system identification to an issuing authority system and the issuing authority system is adapted to authenticate the issuing system and create the digital representation according to the issuing system being authenticated.

In at least one embodiment of the present invention, the entity request system is adapted to capture temporal information and include the temporal information in the entity formation request and the issuing system is adapted to create the digital representation according to the temporal information. In some, but not all, instances, the temporal information is associated with the capture of the biometric information.

In at least one embodiment, the entity request system is adapted to capture location information and include the location information in the entity formation request and the issuing system is adapted to create the digital representation of the formed entity according to the location information. In some, but not all, instances, the location information represents a physical location associated with the created entity.

In one embodiment, the entity request system is adapted to receive a captured entity location representing a physical location of the entity and a captured organizer location representing a physical location at which the biometric information was captured and wherein the entity request system is further adapted to include the captured entity location and the captured organizer location in the entity formation request and wherein the issuing system is adapted to create the digital representation according to a match between the captured organizer location and the captured entity location.

In at least one embodiment of the present invention, the entity creation envoy is adapted to allow retrieval of the digital representation from the immutable storage system using a machine-readable representation taken from the group consisting of a bar code, a quick response code, an alpha-numeric code, radio frequency identification, a graphic and any combination thereof.

The system can include a verified digital token (VDT) associated with the individual and stored on an immutable ledger wherein the VDT is verified from a verification system; a capture device adapted to capture a biometric information, retrieve the VDT from the immutable ledger according to the biometric information and publish a portion of the data included in the VDT. A system can include a verified digital token (VDT) associated with the individual and stored on an immutable ledger wherein the VDT is verified from a verification system; a capture device adapted to capture a biometric information, retrieve the VDT from the immutable ledger according to the biometric information and publish a response according to the data included in the VDT.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

### BRIEF DESCRIPTION OF THE DRAWINGS

FIG. 1A is prior art and an image of an identification document.

FIG. 1B is prior art and an image of an identification document.

FIG. 1C is a diagram of aspects of the system showing hardware and processes.

FIG. 2 is a diagram of aspects of the system showing process flow.

FIG. 3 is a diagram of aspects of the system showing data flow.

FIG. 4A is a schematic of aspects of the system including hardware.

FIG. 4B is a schematic of aspects of the system including hardware.

FIG. 4C is a schematic of aspects of the system including hardware.

FIG. 5 is a diagram of aspects of the system.

FIG. 6 is a diagram of aspects of the system.

FIG. 7 is a diagram of aspects of the system.

FIG. 8 is a schematic of aspects of the system showing hardware.

FIG. 9 is a schematic of aspects of the system showing hardware.

FIG. 10 is a diagram of aspects of the system showing data representing physical objects.

FIG. 11 is a schematic of aspects of the system showing hardware.

FIG. 12A is a schematic of aspects of the system showing process flow.

FIG. 12B is a schematic of aspects of the system showing process flow.

FIG. 13A is a schematic of aspects of the system showing process flow.

FIG. 13B is a schematic of aspects of the system showing physical locations and processes within such locations.

FIG. 14 is a flowchart of aspects of the system showing hardware, process, and data flow.

FIG. 15 is a schematic of aspects of the system showing physical locations and processes within such locations.

FIG. 16A is a diagram of aspects of an embodiment of the system showing hardware and processes.

FIG. 16B is a diagram of aspects of an embodiment of the system showing hardware and processes.

FIG. 17 is a flowchart of an embodiment of the present invention showing the process for creating an entity creation envoy.

FIG. 18A. Is a diagram of an embodiment of the present invention showing hardware and processes.

FIG. 18B. Is a diagram of an embodiment of the present invention showing hardware and processes.

FIG. 19 is a diagram of an embodiment of the present invention showing hardware and processes.

FIG. 20 is a diagram of aspects of an embodiment of the present invention.

FIG. 21 is a schematic of an embodiment of the present invention showing hardware.

FIG. 22 is a schematic of an embodiment of the present invention showing hardware.

FIG. 23 is a diagram of an embodiment of the present invention representing physical objects.

FIG. 24 is a schematic of an embodiment of the present invention showing hardware and processes.

FIG. 25 is a schematic of an embodiment of the present invention showing digital representations of physical objects and their interaction.

FIG. 26 is a schematic of an embodiment of the present invention showing the implementation of aspects of the invention.

FIG. 27 is a schematic of an embodiment of the present invention showing the implementation of aspects of the invention.

### DETAILED DESCRIPTION

The present system provides for the creation, storage, and use of digital identities by pairing the digital representation of an individual with the actual physical individual. The system can include a computer device, a capture device and computer readable instructions that can provide a computer system that can be in communication with one or more databases, an immutable storage system, third party systems, verifications system and any combination. Various systems can be included that can be in a single information system configuration or can be multiple information systems in communications with each other. For example, a first capture device can be a specific computer device designed to capture biometric data, location data, date, time and other input. The system can include a camera, fingerprint reader, DNA reader and other biometric capture device(s). The system can include a camera to capture facial, documents, and physical identification information.

A generation server (e.g., identity recording system) can be used to create digital identification which can include a digital identity record, digital envoy and VDT. A digital identity record (including the VDT) can be a cryptographic reference of the record, can be used as a digital functional equivalent of the individual identity and can be stored immutably. Further this record can be used to reference the individual, and their corresponding certainty level.

The generation server can be used for a variety of purposes such as creating verification of a digital identity and authentication of the digital identity. The generation server can authenticate and verify physical objects, such as an individual, are properly associated with digital representations, verify events and activities are properly associated with digital representations, creating and managing tokens and facilitate authentication and verification of digital representations with physical individuals and objects.

The generation server and the verification system can be centralized, decentralized, immutable, distributed, local, remote, shared, private, virtual and any combination. The generation server can be immutable and persistent so that the information stored on the identity recording system, once storage, cannot be changed. The generation server can include a plurality of computer systems where certain data can be copied onto each computer system. Examples of data storage platforms that can be used by the transaction systems include hard drives, solid state drives, tapes, and cloud storage systems. The immutable data storage system can use quantum, blockchain, crypto-shredding, WORM, append only, distributed ledger technology, immutable cloud storage, immutable record retention (e.g., Oracle Cloud Infrastructure Object Storage, Quantum Ledger Database), any system that makes it improbable, or not known to be possible, to permanently record information such as alteration of the information is not possible without detection and any combination thereof). In one embodiment the immutability is accomplished by the data storage system only allowing records to be appended to the storage media without the ability to modify the record once written. One such system includes blockchain.

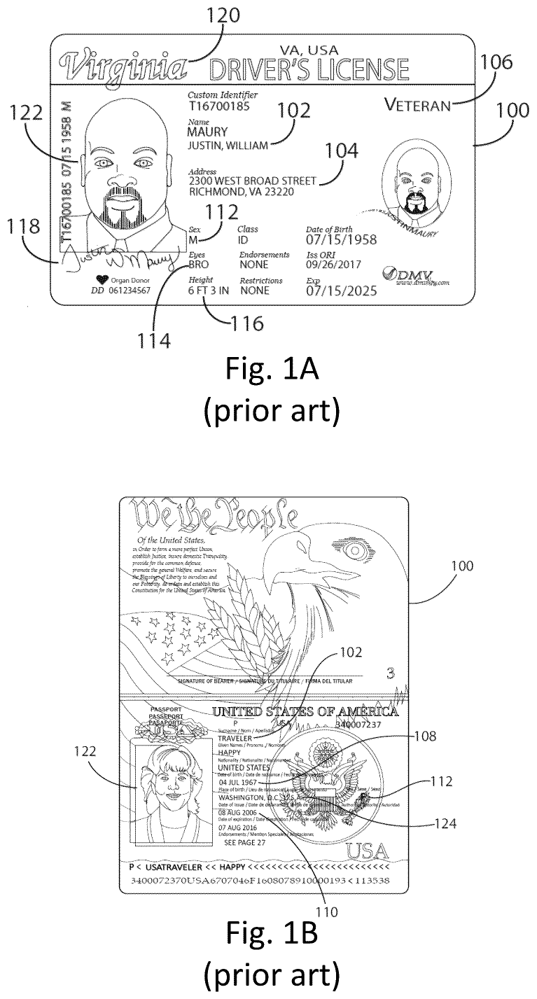

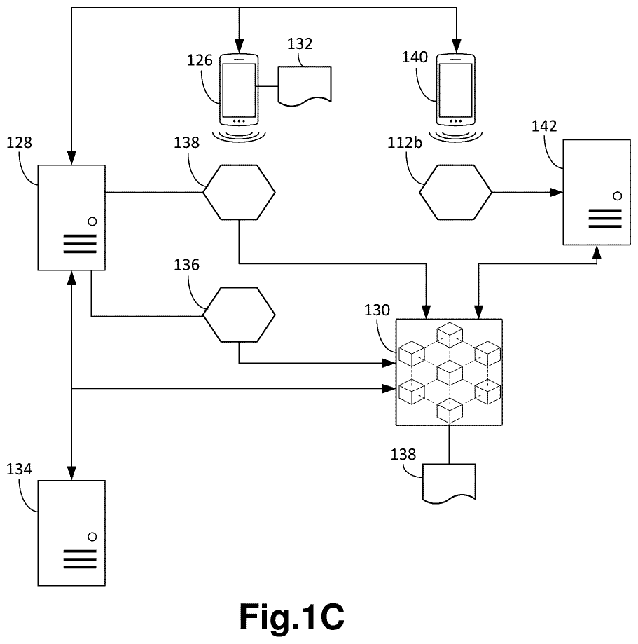

Referring to FIG. 1C, the creation of a digital identity is shown. The capture device 126 can be in communications with an generation server128 through electronic communication such as a secured connection, wired or wireless. The generation server can be in communication with an immutable storage system 130. The user can use a capture device which can use an authentication process such as multifactor authentication to verify that the user creating a digital identification is authorized to use the capture device and authorized to access the identity recording system. For example, when the user initially accesses the generation server using the capture device, the identity recording system, or other system, can request that the user provide an email address, telephone numbers, or other information and send a verification message to that contact information. The user can provide a username and password (the first factor) and an authentication response from their capture device (the second factor). If the user properly responses, the generation server can continue the process. Using multiple forms of identification at the time of account registration verifies that the user is allowed to continue. A capture device 126 can include an input device such as a sensor or camera to capture biometric information such as facial features. The capture device can include a scanner to capture an identification document 132 (e.g., driver's license or passport).

The generation server128 can be in communication with a verification system 134. The verification system can be a closed system that includes previously authenticated and verification identity information. For example, the verification can be a governmental verification system such as maintained by the local, state, regional, or federal government. For example, one verification system includes driver's license information and verification system. This system creates an identity record of an individual that can include a multistep process. First, the individual much complete a form that can include personal information such as name, date of birth, gender, place of birth, social security number, email, contact phone number, mailing address and prior names that may have been used. This form with the personal information is then presented to a governmental facility. The form is submitted to a verifying person along with other documents with personal information such as birth certificate, passports, consular report of birth abroad, certificate of citizenship and the like. Proof of identification can also be provided that can include driver's license, prior or current passports, military identifications, federal, state or city government employee identification, certification of naturalization and the like. A facial image can be taken at the governmental facility and associated with the application and subsequent driver's license. This process can be used by the verification system as well.

The generation server can capture biometric information of the user as well as an identification document and can pass this information to the verification system. The information can be passed encrypted or otherwise over a controlled network. The information can be passed through an application programming interface to the verification system. The verification system can return a VALID or INVALID, VERIFIED or NOT VERIFIED, Pass or FAIL or other like response representing that the biometric information and identification document matches a record on the validation system. If so, the generation server can create a digital identity record 136 that is associated with the individual to provide for a digital identification. The digital identity record can be stored on the immutable storage system can be in a digital wallet of the user. A digital envoy 138 can be created and adapted to retrieve the digital identity record from the immutable storage. The digital envoy can be a code, documents, object, or other item which allows the digital identity record to be retrieved. In one embodiment, the digital envoy can be an alpha-numeric, graphical, image, bar code, digital quick response code or other indicia that can be displayed on a user's device such as a mobile phone. The digital envoy can also be a RFID that can be in a card format, fob, or other footprint that can be presented for authentication. The digital envoy can be presented in a physical or virtual form such as a QR code on a physical media or a QR code on a screen. The digital identity record can be created according to the captured biometric information and the captured verification information associated with the individual. Therefore, a verified digital identity record can be created that can be subsequently authenticated. The system herein can be used to provide for a digital identity that can be used as or a substitute for a credit card, debit card, access card, identification, or other median where verification and authorization is desired.

A capture device 140 can be used to capture biometric information of a user who is seeking to have their identity verified and authenticated. The user can access a capture device 140 that can contain the digital envoy. The digital envoy can be stored or accessible by the capture device 140. The device can capture biometric information and present the biometric information and digital envoy to a transaction server 142. The transaction server can retrieve the digital identity record using the digital envoy and determine if the digital identity is authentic. If so, the transaction server can approve a transaction without the need for exposing personal information publicly. The digital envoy and the biometric information can be used which does not display personal information thereby improving the process of presenting identification documents such as drier licenses and passports.

In one embodiment, the holder of the digital envoy and digital identity information can select which information to provide to someone seeking authentication of the individual. For example, the digital identity information can include name, facial image, driver's license number, birthday, address and other information. The presenter of the digital envoy can select which information to reveal or verify. For example, when being asked for identification from law enforcement in a traffic context, the presenter can elect to provide digital envoy and the driver's license number. In one example, when asked to provide proof of identification that may not be in a traffic situation, the presenter can elect to provide authentication of identification only. Therefore, the presenter can elect which information to present and which to withhold according to the identification authentication request. In one example, the presenter can elect to provide simply an AUTHENTIC or NOT AUTHENTIC status or return to the requesting entity without any further information being revealed. In this case, the digital envoy and biometric information is all that may be needed and presented to the identification requesting entity.

For example, if a buyer wishes to purchase a good from a seller, and the buyer wishes to authenticate the identification of the seller, the system can facilitate these authentications. The seller can present to the buyer a digital envoy and a biometric information which can be used to retrieve the digital identity record, determine if the biometric information matches the digital identity record and provide a response that the biometric information matches or does not match the digital identity record without having to expose the personal information of the buyer. The digital identity record, because it was created using the verification system, allows the buyer to authenticate the identity of the seller.

The system can also facilitate the sale of an object and can charge the buyer, seller, or both a fee which can be the value of the transaction. The value of the object transferred can also be used to determine the value of the transaction. A portion of the above can be used to determine the value of the transaction. The use of the system can have a fee associated with it so that the fee can be the basis of assigning a value to the transaction. For example, when the system is used to properly verify the digital representation with an individual (e.g., pair the individual with the digital representation) the system can charge a usage fee, which can be a value of that transaction.

In one embodiment, the order in which the first record and the second record (e.g.,, validation, authentication, event, transaction and the like) are written on the immutable storage can be used to show that some period of time elapsed between the first record and the second record. This functionality can be added to the verification and authentication process as attempts to improperly tamper with the immutable storage may be discovered when the first record and the second record are not in chronological order. This functionality can also apply to, include, and verify items, people, places, association, activities, events as well as confirm previous recording and storage of such information. For example, the system can capture user information, object information, event information and any combination such as capturing a digital representation of a physical object. The system can create a capture record representing the verified association of the digital representation with the physical individual, object and event. The system can capture and record subsequent information about the object or event such as a subsequent transaction (e.g., in person authentication). A second capture record can be created and associated with the first capture record creating a history of individuals, objects, and events. When this information is captured and stored, attempts to improperly tamper with the immutable storage can be discovered when the metadata of the first record and the second record are inconsistent with the first record and the second record as stored. Each of these transactions can have a fee that can be used to determine the value of the transaction.

In one embodiment, metadata integrity used by the system can be designed to identify inconsistencies with date and time. For example, a capture sensor such as a camera, scanner or other input device can be used to capture one or more images from an individual. Any error or inconsistency in the metadata can be identified by comparing the metadata itself and the hash/block time of the metadata that was committed to the immutable storage system. The difference can be a discrete comparison or can be a determination that the information is within a range.

When the digital identity record is created, the record can include or be associated with biometric information of the individual. This information can be compared to the subsequent biometric information so that a positive comparison can result in the identity being validated and authenticated. If the subsequently captured biometric data does not match the digital identity record, the identity cannot be verified or authenticated during subsequent attempts. Therefore, a transaction can be ceased or the potential for mistaken of fraud can be identified. The individual presented an identity can be authenticated or can be denied.

In one embodiment, the metadata that can be associated with the capture device can include weather conditions, which can include a sun angle, which can be compared with environmental weather conditions to approximate the data capture time. Metadata associated with an image of video can be used to verify weather conditions in the image or video. Time and location metadata can be retrieved from public sources or remote sources and captured with the device metadata to determine of the captured weather in the image or video is the same as being reported locally on that day and at that time.

In one example, a camera included in a computer device can be the capture device and images, or video captured from the computer device of an individual can show the object at a time and location. In the event that the image or footage is disputed, metadata that can include location, date and time and comparing weather visible in the image or footage to reported weather conditions to add verification to the metadata. The metadata that is captured can be dependent upon the capture device and can include metadata associated with a worker, equipment, weather, enterprise software, security hardware and software, material, indicia, smart contracts, public records, authentication information, date, time, location, entity, and any combination of these examples. The biometric data captured may include facial recognition, an iris/retinal scan, a fingerprint scan, a hand scan, a voice print, DNA heart rate signature and any combination.

In one embodiment, an image or video captured can be used to identify an approximate object, event, time, location, and other data. The computer device can capture data in response to an event associated with the physical object. For example, if the physical object changes location, is modified, transferred, integrated, or other action, process or procedure associated with the physical object can signify an event.

The first capture device metadata can be used to create the first record which can be a first event record. The first event record can be stored on the immutable storage, used to create the digital identity record and digital envoy. The second capture device metadata and object data captured by the second computer device can be used to capture assert identity information that can be authenticated by using the digital identity record. During data capture by the first capture device, object indicia can be captured where the object indicia is associated with the object and verification can occur. The object indicia can include a still image of the object, a label affixed to the object, a radio frequency identification (RFID) tag, an ultra-high frequency (UHF) tag, a bar code, a QR code, a Bluetooth beacons, alpha-numeric characters, and any combination thereof. The object indicia can be included in the first event record and stored on the immutable storage. When a change in time, location or other event occurs the second computer device can capture the object indicia. Once captured, the object indicia can be compared to the object indicia in the first event record and if the two matches, then verification and authentication exists that the physical object associated with the second event is the same physical object that was present at the first event. In one embodiment, the second capture device can capture data, transmit the data to the computer system 102 and computer readable instructions on the computer system can perform the comparison of the object indicia capture as the second event with the object indicia included in the first event record.

The input into the capture device can include username and password. In one embodiment, the digital identity can be associated with digital storage such as a digital wallet. The identity and other information that is received can be used for authentication and verification of the identity of the user. The user can provide biometric information that can be compared to a local or remote database of identification information and the identity of the individual can be verified and authenticated. The object information can be captured and can include metadata related to the object including file types, creation dates, file attributes (e.g., format, compression, protocol, and the like), names, headings, and other data about the object and object information. The object information and the event information, along with its metadata can be compared metadata such as location and time to verify that the object information and the event information are authentic. The system can create a capture record which can be information about the capture of the object and event information and the capture record can be stored on the immutable storage system. Therefore, the capture record can be subsequently retrieved and compared with the original or subsequent object and event information for validation. The object information and the capture information can include a unique identifier associated with the object or event.

The system can retrieve the first capture record and a second capture record and compare the respective records to determine if the physical object is the same physical object at the first event and the second event. If the capture record does not include consistent information, a notification can be provided indicating that the identity information has been changed, modified or otherwise different between the first capture and the second capture. This can indicate an attempt to falsify identity information or the presence of a mistake.

The system can therefore pair the identity of an individual with a digital representation, such as a digital identity record, and subsequently verify identity without exposing personal information to the public. This system can provide for authentication and verification at multiple time and locations using multiple system as the capture device need only receive biometric information and present the digital envoy.

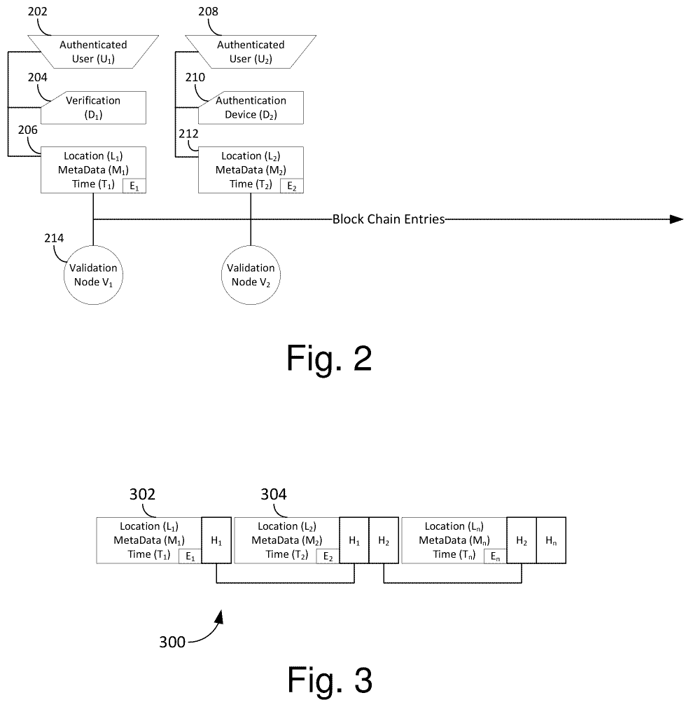

Referring to FIG. 2, one embodiment the individual can be authenticated and verified using a capture device at 202. The user can be authorized to use the capture device or to perform data capture for creation of the digital identity at authentication. The capture device can be authenticated at 204 representing the capture device is the correct capture device and is in working order. The metadata that can be captured by the capture device can include a location, a time and additional metadata shown as 206. The user can be a first user and in one embodiment a second user of a capture device can be authorized at 208 so that the user can be authorized to use the capture device or to perform data capture. A second capture device can be authenticated at 210 representing the capture device is the correct capture device and is in working order. The metadata that can be captured by the capture device can include a location, a time and additional metadata shown as 212. In one embodiment, the first record and the record can be committed to immutable storage such as blockchain using validation nodes included in the immutable storage structure. The capturing of data and the writing of data can be associated with a fee that can be used to determine the value of the transaction. A validation 214 can be created and stored. The event record E₁, which can be represented by data taken from U₁, D₁, L₁, M₁, T₁, or other data, can have a validation code V₁. When the even record is retrieved, a second validation code Via can be determined and compared with V₁. If these validation codes match or are within an acceptable range, validity of the data from storage to retrieval can be determined. The capture device 208 can be used to authenticate an identity and can use the digital envoy and biometric information to provide a status such as VERIFIED or NOT VERIFIED of the like.

In one embodiment, the generation server can be used to capture biometric information of an individual. This information can be used to create the digital identity record which can be stored on the immutable storage system and associated with a digital envoy. The digital identity record can represent that certain individual biometric information was captured at a specific location, date, and time. The date and./or time can by temporal information that can be included or used to create the digital identity record. In one embodiment, the user of the generation server can have the user's information captured as well do that the digital identity record can include information concerning the creator of the record. When the identify record is captured the individual subject to the identify record can travel to another location. At the other locations, the individual can present the digital envoy and biometric information so that a authentication system can determine that the presenting individual of the digital envoy and the biometric information is the same individual as when the digital identity record was captured. This embodiment can be advantageous when facilitating immigration wherein the individual may not have a governmental issued identification. The system allows for a digital identity to be associated with the individual and which can be later authenticated to show that the same individual is identified.

Referring to FIG. 3, in one embodiment the second event record 304 (e.g., identity verification) can be linked to the first event record 302 (e.g., digital identity creation) to create a digital audit trail 300 that includes indicia verifying that the individual remains the same individual throughout a process. A validation record can be created for the first event, the second event, the first plus second event and any combination including the inclusion of n additional records. The system can also record changes in the event or object including changes in the locations, time, biometrics, thereby providing an audit trail of any changes.

The capture device can include biometric identification devices such as a camera or other capture devices that can capture facial recognition, voice recognition, retinal scans, fingerprint scanners, hand scanners, DNA, and other biometric information. In one embodiment, the capture device can include two-factor authentication prior to allowing the verification process to occur.

The capture device can be contained in a housing such as a kiosk and can be physically associated with a location. The location can be defined by a boundary representing the perimeter of the location. The system can include a sensor and reader which can be selected from the group consisting of radio frequency identification (RFID) detector, ultra-high frequency (UHF) detector, a bar code scanner, a QR code scanner, near frequency communication (NFC) device, Bluetooth beacons, an optical character recognition (OCR) device and any combination thereof. An environmental sensor, such as a weather sensor or weather station, can be in communications with the or included in the housing and configured to record the weather and other environmental conditions at the location and at different times during the verification process. If the environmental sensor detects a change in the environmental condition, it can represent an event. The use of the kiosk can be associated with a fee (e.g., rental or sale) and can be used to determine the value of the objects or event (e.g., transactions) that are performed at the kiosk.

The system can also use smart contracts where the verification of identification can be one of e criteria for implementing the smart contract for self-execution upon satisfaction and verification or the necessary individuals. For example, when an object is delivered from a seller to a buyer and the buyer verifies the buyer's identity, a smart contact can instigate payment to the seller.

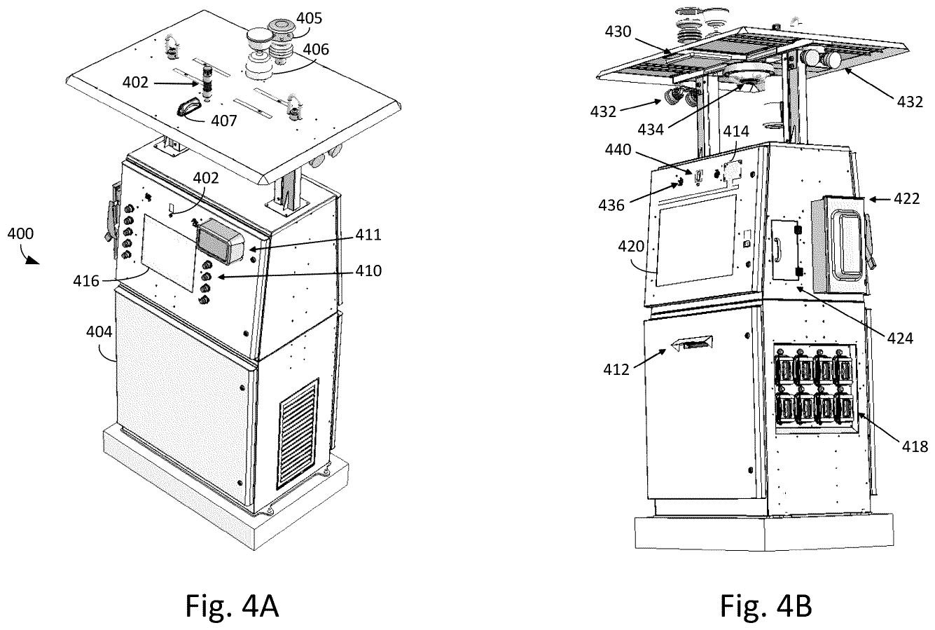

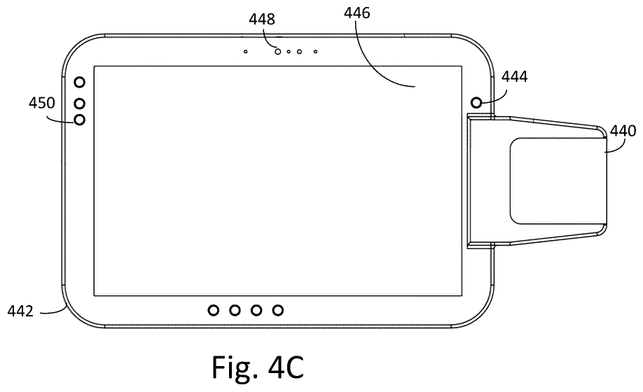

Referring to FIGS. 4A and 4B, in one embodiment the capture system can be contained in a housing 404 can be physically associated with the project location, virtually associated with the project location or both. The housing can be a kiosk in one embodiment. A unique location marker can be disposed at the location to uniquely identify the location. For example, a transmitter such as a RFID can be associated with the project location by embedding it in a permanent fixture such as a concrete slab, foundation, structure, and the like. The system can read the information from the location marker and associate its actual location with the location. The location marker can include alpha, numeric, or graphical information such as a number, letters, barcodes, QR code, physical or geographic coordinates (e.g., GPS coordinates), passive transmitter, active transmitter and the like. Each system can have a unique identifier and each project location can have a unique identifier.

The first side of the system can include a camera 402 for obtaining images of materials, equipment, individuals, or other items entering or leaving the project location as well as images of individuals along a perimeter. The camera 402 may capture biometric images upon which biometric recognition may be performed. Multiple cameras may be placed on or around the housing. The cameras may have biometric recognition and motion detection capabilities. System 400 may include one or more cameras 402 that can be used as biometric-based identification devices to confirm the identity of individuals entering, leaving or on the perimeter of the project location. System 400 may include an antenna 406 for communicating with a network including a wireless network, Wi-Fi network, Bluetooth, quantum networks, cellular network (e.g., 4G or 5G network) and any combination. System 400 may include a housing 404 made of suitable weather resistant material, appropriately sealed to protect the internal hardware. System 400 may include a display 416, such as a touchscreen display, upon which information may be displayed and entered. The display 416 may include an integrated camera that may be used to capture images and that may be used in performing facial recognition of individuals. The display may also include or operatively associate with one or more integrated speakers for providing audio output, a microphone for receiving audio information to facilitate two-way communications to a remote location. The system 400 may include a scanner 412 for scanning items, such as deliveries, as will be explained in more detail below. The scanner 412 may be, for example, a QR scanner, barcode scanner, an Optical Character Recognition (OCR) or another scanner 411 in some instances. Actuators such as button 410 can be carried by the housing and connected to a controller, computer medium, computer of other information processing device. One side of system 400 can be used for deliveries and inspections. A delivery person may scan delivered materials, equipment, or other items via the scanner 411 or 412 and may interface with the system using the touch screen display 416. An inspector may scan or take images of inspection documents via the scanner 411 or 412 or camera and may interface with the system using the touch screen display 416. In some embodiments, there may be fewer sides in which to interact with the system for all authorized personnel. An overhang may be provided to assist in decreasing glare and protecting some of the items on the housing from the weather.

Another side can include a touch screen display as well as a scanner 412. Display 416 may include or be operatively associated with an integrated camera for capturing images, speakers for providing audio output and a microphone to facilitate two-way communications with a remote location. Still further, this side of the system may include data ports. The system may be accessed to gain access to equipment, tools and to sign in or sign out when leaving or entering the project location, as will be described below.

Another side of the system can include location 420 where information such as permits, specifications, instructions, tax information, plans, and the like may be displayed. In some embodiments, the information displayed may assume electronic form so that a video display is provided in the housing. A tax map submap (TMS) number for the project location may be displayed on the housing. Other location identifying information can be displayed such as location number, store number, assembly number, area within the project location and the like. In addition, the site address may be displayed on the system. The site address may refer to both the mailing address for the project location and/or other physically identifying information associated with the location.

Another side of the system can include an access panel 422 may be provided to access a breaker box for the system. An additional access panel 424 may also be provided to access internal components of the system. Still further, access panel 424 may be provided to gain access to a power source for providing power at the project location. The access panel 418 may be under programmatic control in some instances to regulate access to the power source. If access is granted, the panel is unlocked, whereas if access is denied, access panel 418 is locked. In some embodiments, access to the power supply may be controlled by controlling the flow of power to the power source under programmatic control from the controller. These control mechanisms may be used separately or in conjunction.

Housing 404 of a capture device can include a worker side that is configured to be used by a worker at the project location. The housing can include an alarm indicator 407 that can be actuated as described herein. The housing can include a weather station 405 that can include an integrated or separate fluid (e.g., rain) collector. Biometric reader 414 can include an iris scanner, fingerprint scanner, palm print scanner, facial scanner, or some combination. Display 416 can be proximity to input assemblies such as buttons 410. The housing can include a field receiver 430, lights 432 and camera 434. One or more cameras can provide a 360° field of view and include a wireless connection for transmitting images to a remote computer device. The images can also be used for input to the system including input allowing the system to identify delivered materials. The system can include one or more second cameras 440 such as webcams disposed at various locations around the system for capturing images. The lights can include motion activation and photoelectric activation. Speakers 436 can be included to provide audio information to a user, worker, inspector, or other party using or near the system. The audio information can include instructions, alarms, and the like. Power junction can include a shut off switch that can be used in emergency and non-emergency situations. The system can include a secondary power source, such as a battery, so that when the main power is shut off, an alarm can sound, notification can be sent to a remote computer device or other indication that the system or power source has been powered down. The system can include a hand scanner (not shown) that can be protected by a hand scanner access door. A document scanner 412 can be included in the system for receiving physical documents, converting the physical document into a digital representation, and storing the digital representation on the computer readable medium or the immutable storage. The system or housing can include electrical outlets 418 for providing power to various tools and equipment at the project location including recharging batteries. The system can include a wired connection to remote computer devices of a transceiver to provide a wireless connection to remote computer devices. Each activity recorded by the kiosk can be assigned a value that can be based upon a predetermined fee or a value that is associated with the transaction, object, or activity itself.

Referring to FIG. 4C, the capture device can be mobile. In this example, the capture device 440 can be attached to the computer device 442 or can be integrated with a computer device. The computer device can include a camera 444, display 446, microphone 448, speakers 450 and other input.

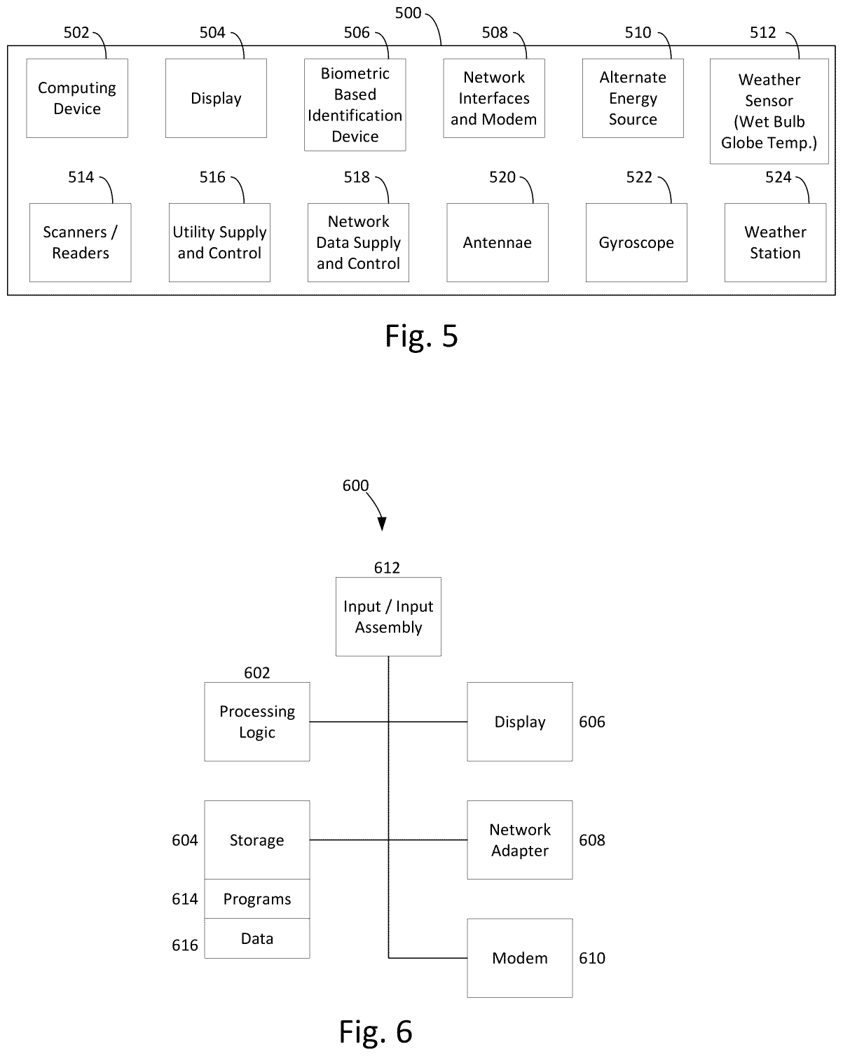

FIG. 5 depicts components that may be included in the system of exemplary embodiments even when not included in a housing. The system may include a computing device 502. The computing device 502 may take many different forms indicating a desktop computing device, a laptop computing device, a mobile computing device, an embedded system, a smartphone, special computer device, custom computer device, or the like. A display 504 may be integrated with the computing device 502 or as a separate device, such as a liquid crystal display (LCD) device, a light emitting diode (LED) display device or other types of display devices on which computer information may be displayed. One or more biometric-based identification devices 506 may be provided. As will be explained in more detail below, multiple biometric-based identification devices may be used. Network interfaces and modem 508 may be provided. The network interfaces may interface the computing device 502 with a local area network or a wide area network wherein the networks may be wired or wireless. A modem may be provided to communicate telephonically or over cable lines with remote computing devices.

The system 500 may include various scanners and readers 514, such as those described above relative to housing. System 500 may include a utility supply and control 516 and a mechanism for turning the utilities, such as power, gas and/or water, on and off under a programmatic control. The system 500 may include an internet data supply control 518 and a mechanism for turning the access to this service on and off under a programmatic control. Programmatic control may be provided to grant or deny access to such resources. The system 500 may include an antenna 520 for wireless communications signals to receive and transmit. System 500 may include a gyroscope 522 to monitor any movement of the system. The gyroscope 522 may indicate motion indicative of whether someone is trying to move or tilt the housing or other component of the system. Logic may be provided to send a notification in such an event where the gyroscope indicates substantial enough movement. System 500 may include a weather station 524 to measure current weather conditions, such as temperature, air movement, humidity, precipitation, barometric pressure, direct sunlight, and the like. Input from the weather station 524 may be used to inform decision making by the system in some instances. Alternatively, the weather may be collected via software, such as from a weather service or other weather source. Similarly, system 500 may include a weather sensor 512. The sensor can be a wet bulb globe temperature adapted to measure, among other things, heat stress in direct sunlight, which accounts for temperature, humidity, air movement (direction and speed), sun angle and cloud cover (solar radiation).

FIG. 6 shows an example of a computing device 600 for the system. The computing system may include processing logic 602, such as microprocessors, controllers, field programmable gate arrays (FPGA), application specific integrated circuits (ASICs) electronic circuitry, and other types of logic. The processing logic performs the operations of the computing device 602. A storage device 604 may also be provided. The computer readable medium and/or data storage device 604 may take various forms, including magnetic storage, optical storage, etc. Storage capability 604 may include computer-readable media, including removable computer readable media, such as disks, thumb drives and the like, or disk drives, solid state memory, random access memory (RAM), read only memory (ROM) and other types of storage. The computing device may include a display 606, such as an LCD display, an LED display, or other types of display devices on which video information may be displayed. The computing device 600 may include a network adapter 608 for interfacing with networks and a modem 610 for communicating wirelessly, over telephone lines or cable lines with remote devices. The processing logic 602 may use information stored in the storage device 604. In particular, the processing logic 602 may execute programs 614 stored in the storage and may access and store data 616 relative to the storage device 604. The computational functionality of the system described herein may be realized by the processing logic 602 executing the programs 614. The system can include input or input assembly 612 that can include biometric reader, camera, microphone, scanner, sensor and the like.

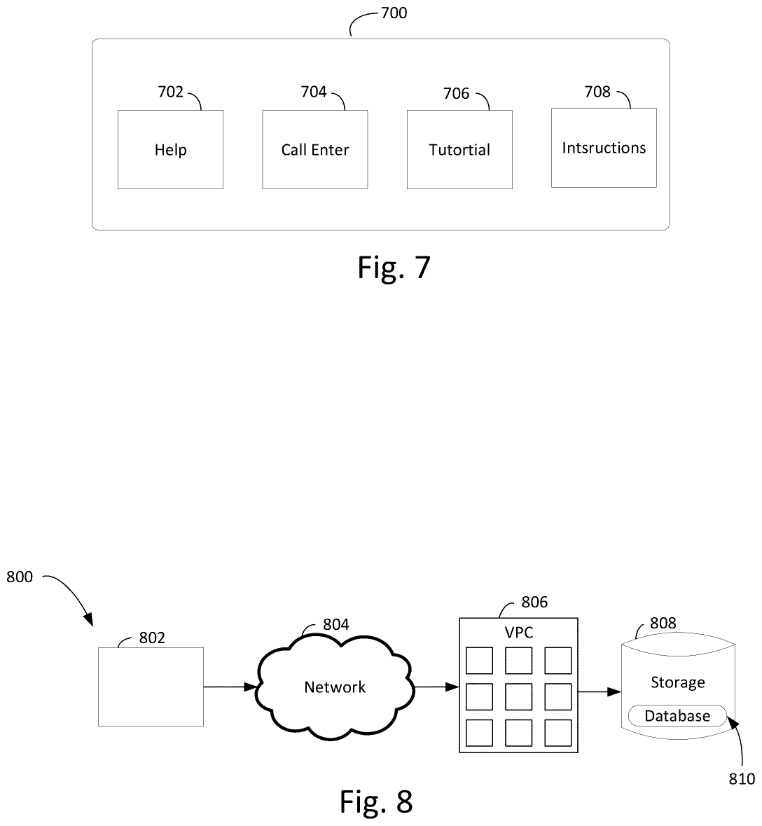

FIG. 7 shows an example of a user interface on one or more displays where the user interface may include activatable elements. A user may depress these activatable elements or select these activatable elements using an input device, such as a mouse, keyboard, touchscreen, buttons, or the like, to activate the components. The display may include a help element 702 that may be activated to obtain help information regarding use of the housing. It may also contain real time projects or process plans. It may also include “how to” assistance including videos related to the various projects, stages, processes, and tasks performed at the project location. The user interface on a display may also include a call center activatable element 704. Selection of the call center activatable element 704 may cause a call to be initiated with a call center so that the individual using the system may have a telephone and or video conference with personnel at the call center. The user interface on the display may also include a tutorial activating element 706. Selection of the tutorial activatable element causes a tutorial to be displayed to teach the individual about operation of the housing. Instructions can be provided to the user at 708.

As shown in FIG. 8, the exemplary embodiments may be implemented in a decentralized computing environment 800, that may include distributed systems and cloud computing. FIG. 8 shows one or more systems 802 that may be in communication with a remote cluster 806 via network 804. System 802 can be identity recording systems, verifications system or transaction system and multiple of such systems can be in communication with an immutable storage system. Cluster 806 may store information received from system 802 and provide added computational functionality. The network may be a wired network or a wireless network or a combination thereof. The network 804 may be a secure internet connection extending between the system 802 and the cluster 806, such as a virtual private cloud (VPC). The server may be a computing device and can be in communication with the site computer device. Cluster 806 may include access to storage 808. Storage 808 may include database 810 in which information regarding a project location is stored in a consistent manner.

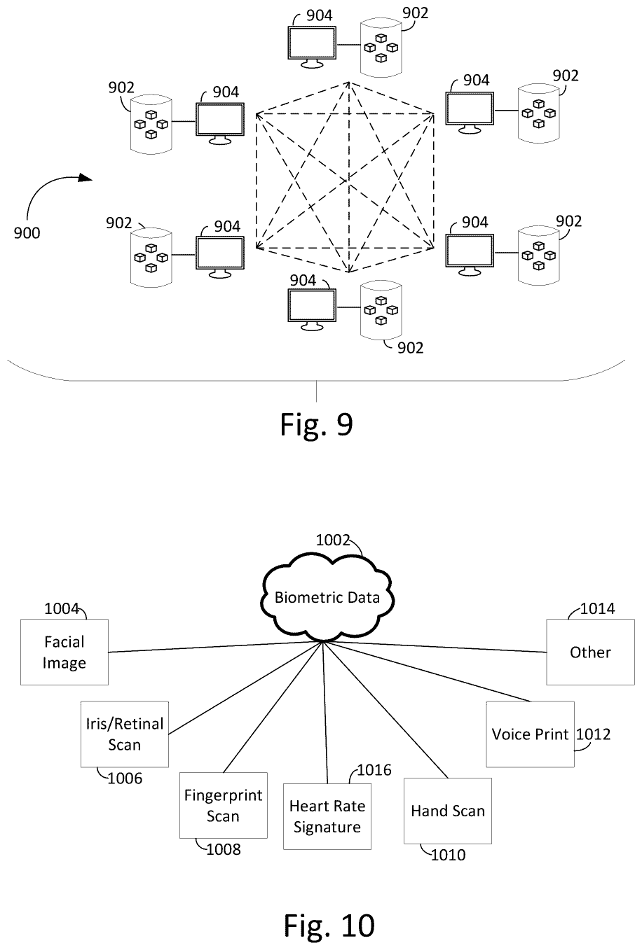

FIG. 9 shows diagram 900 of an example of a peer-based network where an immutable storage 902 is broadcast and shared among the nodes 904. A node can include a verification system and a transaction system. This network may be resident in the VPC cluster 806 (FIG. 8) or in a network for example. The nodes 904 may represent computing resources, such as server computer systems or other computing systems, residents at the parties identified in FIG. 9, for example. Each node that has access to a copy of the immutable storage system 902.

The various computer devices, including the server and site computer device (e.g., system, controller, and any combination), can be in communications with immutable storage system. The immutable storage system can include a distributed ledger, immutable database, block-chain structure, and the like. The communications between the various computer device, including the server and the site computer device and immutable storage can be a global communications network, wide area network, or local area network, delivered to a computer readable medium from one device to another (e.g., USB drive, CD, DVD) and can be wired or wireless.

Referring to FIG. 10, biometric data 1002 that may be obtained by biometric-based identification devices at the project location to attempt to identify individuals. Biometric data may include facial recognition 1004, an iris/retinal scan 1006, a fingerprint scan 1008, a hand scan 1010, a voice print 1012 or heart rate signature 1016 or other input or sensor 1014. It should be noted that other types of biometric data may also be used in exemplary embodiments to help identify individuals uniquely. Also, an individual may be required to provide multiple types of biometric data in some instances.

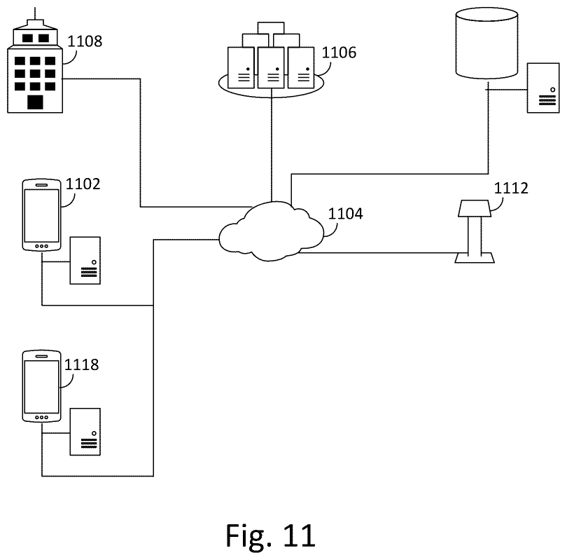

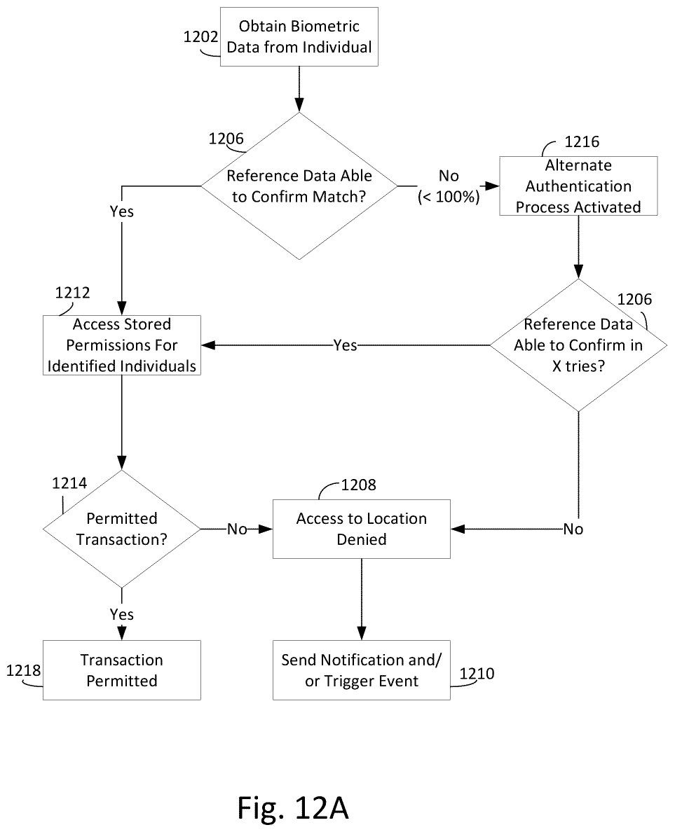

Referring to FIG. 11, computer device 1102 can be in communications with a network 1104 and immutable storage system 1106. The capture device connect to a computer device or is in communication with the computer device or can be a computer device itself. The capture device can obtain information from other sources 1108 such as third-party time and date information (e.g., atomic, and nuclear clock operators, weather information). The capture device 1110 can be mobile 1102 of stationary 1112 so that the capture device can be placed near or at a user, object, or event location. Once user identification information, object information, event information, capture information is stored, another mobile computer device 1114 or other computer device 1116 can retrieve the stored information. The information can include an identifier that can be a physical identifier or digital identifier such as a QR code that can be affixed to the object or associated with an event. When the identifier is scanned, the various information and records can be retrieved. The system can include verification of an object and event with its digital representation with a subsequent computer device 1118. In one embodiment, the digital identity can be created by device 1102 as part of a verification process. Device 1118 can be used as part of an authentication process.

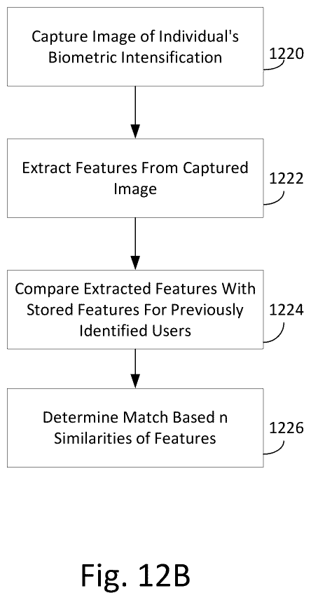

Referring to FIG. 12A, when a user wishes to use a capture device, the capture device can obtain biometric information from the user as 1202. A determination can be made at 1206 if the information from the user can be verified. If not, an alternative authentication process can be used at 1216. If the alternative method for user authentication is used, the system can determine if a predetermined number of tries are attempted at 1206 and if so, deny access at 1208 or retrieve the permissions for the users at 1212. If the user is permitted access at 1214, transaction approved at 1418, otherwise a notification that the user attempted to access the system can be created at 1410.

Referring to FIG. 12B, the image of the user can be captured at 1220. Features can be extracted from the captured image at 1222. The biometric information can be sent to a verification system with additional information and a comparison 1224 can be used to determine if the verification system confirms or denies that the provided information match the information at the verification system at 1226. Therefore, the system can verify identity information while the personal information remains at the verification system without having to expose the personal information to the public. In one embodiment, additional information such as name or other information can be sent to the verification system and if the identity is confirmed, the digital representation can be created as well as the digital identity record and digital envoy. The digital identity record and digital envoy can be stored on the immutable storage system.

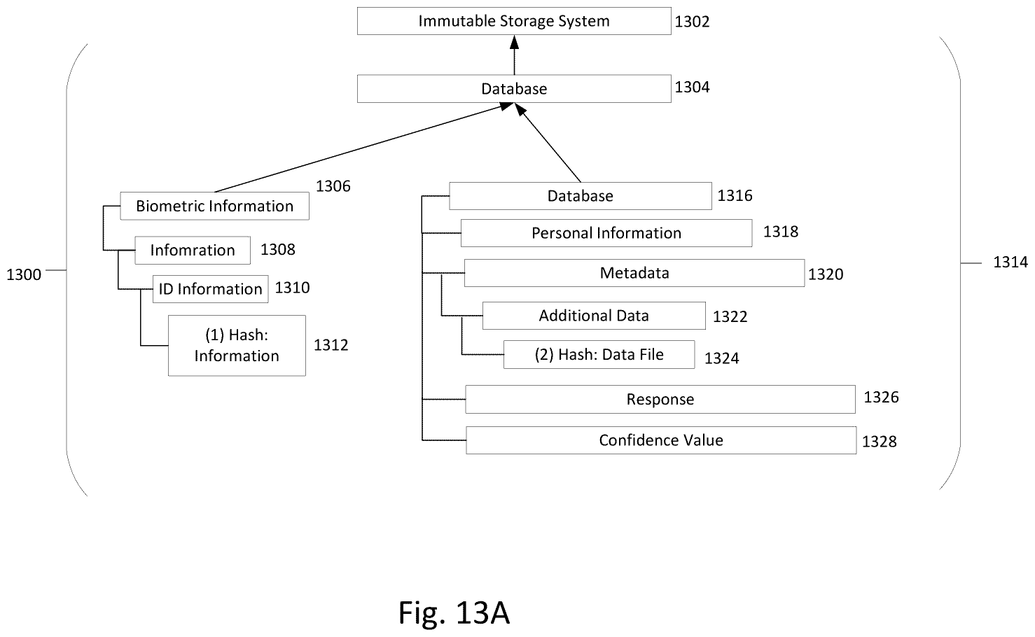

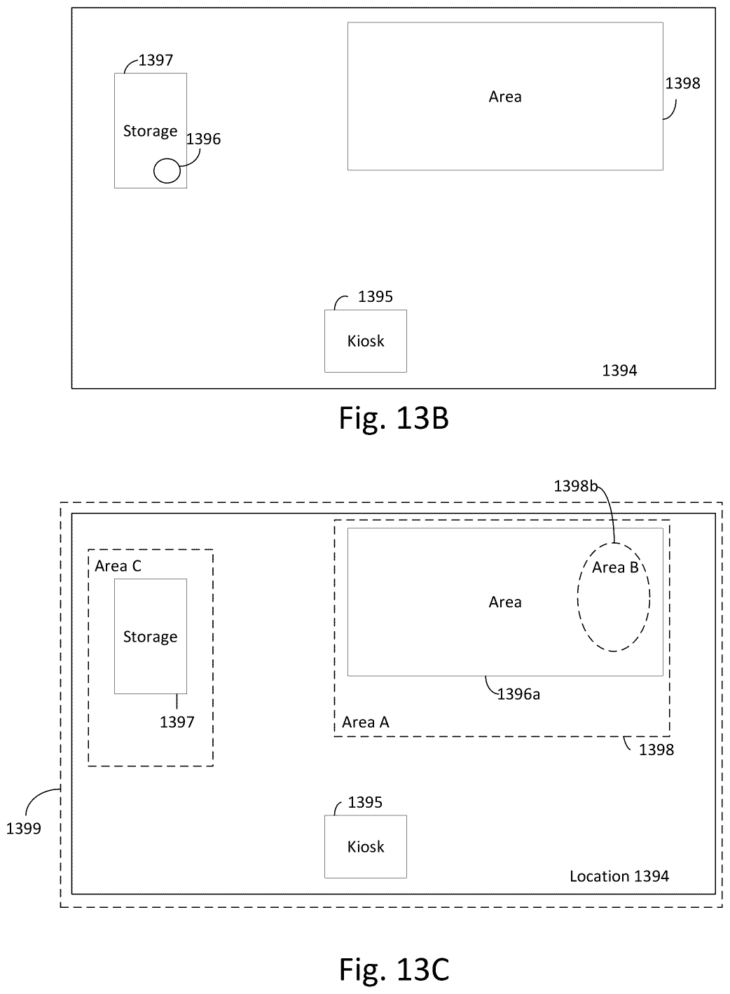

FIG. 13 shows an example of the system in use is shown as it applies to the creation of a digital identity record. An immutable storage system 1302 can receive information and store information. One or more databases 1304 can be included in the system or can be in communications with components of the system. Information can reside on the immutable storage system and the databases. Information can be secured stored on a database with an index, pointer or other access element stored on the immutable storage system allowing access to the information to one or more databases.

The capture device process 1300 can capture biometric information 1306 using a capture device and capture process that can securely capture identifying information 1308. Identification information 1310 can be captured and a hash 1312 of the information can be created. The biometric information and the identification information can be translated into a binary template that can have a hash associated with the information. Once captured, the information can be provided to authentication system 1314 for authenticating the identity.

The verification system can include database 1316 that can have authenticated and verified the identity of the individual. For example, the process for applying for a drivers' license require governmental verification with facial images of the individual making the department of motor vehicles database a verified data and verification system. The information included in the verified system can include personal information 1318 such as name, birthday, address, etc. The database can include metadata 1320 and additional data 1322 that can be associated with the individual record such as when the record was created, where it was created, and who created or verified the information in the record. A hash of the datafile 1324 can be created and stored. The verification system can receive identification information, use the information to retrieve an individual's identification record, determine if there is a match and transmit a response 1326. The response can be verified or not verified or other similar designation or information representing if the query into the verification system resulted in a match. The verification system can also send a verification confidence value 1328 that can represent a scale for confidence that the query matches a record. For example, of the submitted information is a facial image, the facial image can be matched to the database of the verification system and if XX number of points match that is less than 100%, a confidence score can be returned representing that there is likely a match, but the determination was not 100%. In one example, a confidence value can be between zero and six. The facial recognition that can be part of the verification system can measure distance between the eyes, distance from the forehead to the chin, distance between the nose and mouth, depth of the eye sockets, shape of the cheekbones and contour of the lips, ears, and chin. If all but one of these matches, the confidence can be five rather than the highest, in the example, of six. By querying the verification system, the personal information of the verification system does not need to be exposed to the public.

Information that can be included in the verification system or used to query the verification can include event information, GPS data and addresses, times, attendees, and other object or process properties. The systems may store an object requirement record hash notification from the immutable storage, indicating that the hash value for the individual, object or event information has been referenced on the immutable storage. Information tracking the individual, object information or record may be stored in the database. A hash value resulting from passing information through a secure hash function can be stored, transferred and referenced on the immutable storage system.

The captured information and the ability to read the digital envoy can be accomplished using various scanning and reader technology. A machine vision system may be provided. The machine vision system may capture an image of objects and events and process the image to determine the nature of the objects as well as the quantity. Moreover, the machine vision system may capture an archival image that may be indicative of the state of the objects at any given time. A QR code scanner may be used where QR codes are on an object. Similarly, a bar code scanner may be used where bar codes are on the items or on documentation delivered with the items. Still further, an RFID reader may be provided to gather information regarding the identity. Still further, a document scanner can be used to capture identification information if needed.

In one embodiment, a user can be an inspector or other official that can interface with the system and perform steps that may be performed in such an interaction. Initially, the identity of the inspector may be confirmed using the biometric data or manually using the touchscreen on the system. The inspector then performs the inspection of the appropriate individual, object or event at a proper location. The inspector then may record notes and/or post certificates or notices at the system. Additionally, the inspector may use technology available via the system such as OCR scanner or the like to capture appropriate information.

The steps that may be performed in this process can be captured by image capture devices, such as still cameras or video cameras, from multiple adjacently situated systems that can be used in conjunction. Video feeds or still images may be obtained from the image capture devices from multiple systems. The video feeds or images may then be processed, such as by the cluster described above, using software such as motion detection software, thermal image analysis or other image analysis software to identify activity that may warrant a response. When a motion is detected, it can trigger data capture for that event.

In some instances, payment may be made electronically, such as through crypto currencies, like Bitcoin or Ether, or via a stable coin whose value is pinned to an item like a paper currency or the like. A cryptocurrency is a digital currency built with cryptographic protocols that make transactions secure and difficult to forge. Other Suitable forms of electronic payment includes Automated Clearing House (ACH) payment, Electronic Funds Transfer (EFT), card payments, other types of bank transfers or other types of electronic wallet transfer. In the case where crypto-currency is used, the crypto-currency may be delivered to the digital wallet of the supply company at a specified wallet address or account. The ledger may be updated to show that the contract is complete. Payment requires that the payor has sufficient funding in their digital wallet. If not, the smart contract will not be written on the immutable storage system. If there is sufficient funding, payment is made, and the contract is written onto an immutable storage system.

There can be a relationship between smart contracts and the individual, project, process, or event. A value can be associated with the smart contract, the individual, project, process, object, and event and can be used to determine a transaction value. Initially, a schedule can be received. For example, the assembler identity can be certified, and a project schedule based in part on the design and material requirement record created with that individual. Based on the project schedule, smart contracts may be constructed that use the immutable storage system for contractual arrangements associated with the project or process. The smart contracts are implemented in software and in this case are used to provide electronic payments to parties for activities relating to the project or process using, for example, electronic payments, crypto currencies, fiat currencies and other forms of payments. The smart contracts may specify the conditions required for payment and may specify the amounts of payment. Smart contracts may also play a role with deliveries. Delivery and/or materials information is obtained regarding delivery to the project location for the project or process. The information obtained can include if the materials delivered match the material requirement record, manufacturer, and/or supplier which can be confirmed by multiple parties.

To pair an individual with its digital representation the system can capture events at various points of an event, transition, or other activity. Pairing the physical with the digital representation can include several elements or components. Included in the pairing process can be the physical observation of the individual, an activity and then associate the physical with a digital representation so that the physical is properly associated with the digital representation. This verification provides trust that the digital representation is accurately associated with the physical as a factor rather than simply trusting that the digital representation is accurate. This system can use manual or automated processes to physically observe and associate the material with the digital representation during various events from raw material to final deliverables. Verification can also use the metadata that is associated with the interaction of physical items by individuals and electronics when the item is created, transported, installed, activated, and destroyed. The metadata that can be captured and placed into immutable storage can provide stakeholders with an audit trail of history for their physical asset using a verified paired digital representation. This process can be used for pairing a biometric identifier with an individual.

Referring to FIGS. 13B and 13C, location 1394 can include the capture device 1395 disposed at a stationary location or the capture device can be portable and disposed at the location. An individual 1396 can be at a location 1397 and associated with certification or another event 1398. The system can record the individual and any event or activity wherein the event can include arrival of an individual, receipt of an object, use of an object at the event area and a transaction or other event that occurs involving the individual, location, or object. The location 1394 can be geofenced so that the location of an object or event can be compared with the physical location. The individual can be authenticated at a specific location in order to determine not just that the identity is authentic, but that the individual is at the specific location. For example, the digital envoy can be presented at a voting location and the individual can be authenticated as well as recorded to have been at the location to reduce or avoid voter mistakes and fraud. In this case, the individual can present the digital envoy without necessarily having to present persona information since the digital identity record is retrieved with the digital envoy and the voting location needs only know that the identity is authentic and matches the presenting individually (e.g., through biometrics).

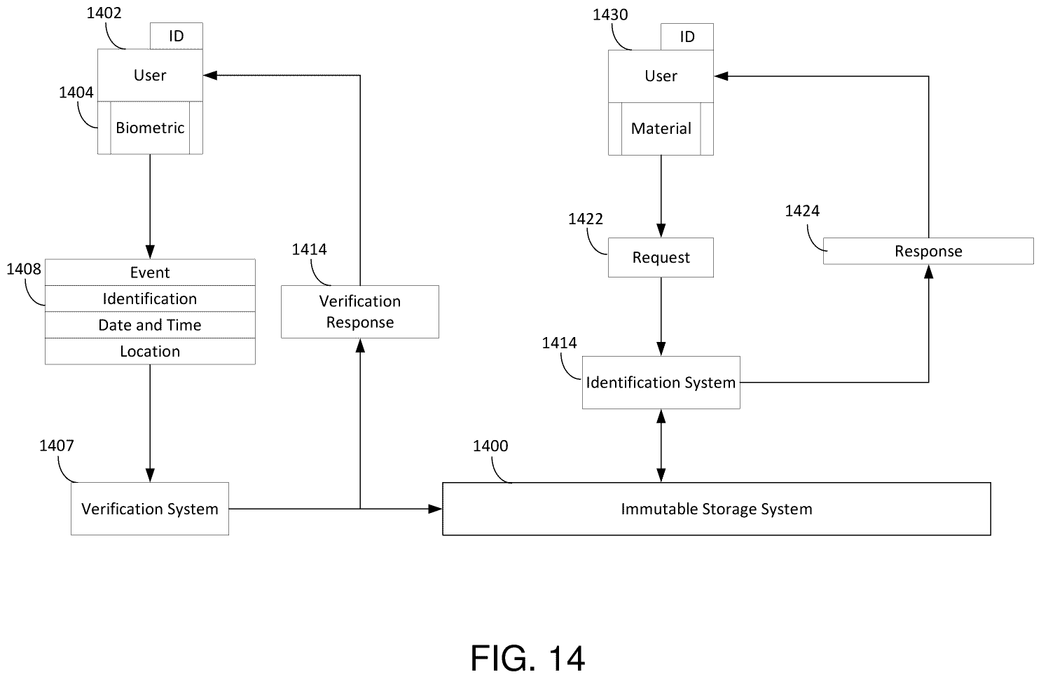

Referring to FIG. 14, a user using a capture system 1402 can provide biometric or other information 1404 that can be sent to a verification system 1407. Information 1408 that can be used to create the digital identity record can include event information, identification information, personal information, date, time and location information. The digital identity record can include or be associated with other information such as diploma information, license information, compliance information, background check, financial status, citizenship, and any combination thereof. For example, when a user is granted a diploma, the biometric of the individual can be captured with the graduation of other diploma related information and associated with a digital representation. The digital representation can be a token, digital envoy, block and other storage device and can be stored on an immutable storage system. When the individual wishes to show that the individual has a diploma, the user can present the digital envoy and biometric information which can be used by a authentication system to return a authorization status that can include that the individual has graduated.

A self-verification system can include an individual presenting biometric information and potentially other identifying information that can be used by the generation server to create the digital identity record and the digital envoy. In this case, the individual could present biometric information that can be used for the creation of the digital identity record. The individual can also present identification with biometric information. The generation server can use other information including metadata such as location, time, and date.

The information can be transmitted to a verification system and the response provided to the same or different capture device. The response can include an affirmative/positive comparison or denied/negative comparison. The verification system can send the response directly to the capture device or can store the response on the immutable storage system 1400 or other database that can be retrieved or received by the capture device. The capture device 1402 can be used to create a digital envoy such as a token that can be stored on the immutable storage system which can represent that the individual identity information has been verified with the verification system. Therefore, a digital representation can be stored on the immutable storage system and can represent the verification of an individual identity. The digital representation can be used to authenticate the identity of the individual without the verification system needing to verify the identity at each query.

A user of capture device 1430, can capture identity information such as biometric information and provide a digital representation (e.g., token) that can be used to send a request 1422 to an identification system 1412 that can result in the digital representation being retrieved from the immutable storage system. If the information sent to the identification system matches the information retrieved from ten immutable storage systems, a response 1424 can be sent that affirms that the identity presented is authentic. In one example, the user of the capture device captures the presenting individual's facial image. The presenting individual also provides a digital envoy that is associated with the presenting individual. The capture device or identification system retrieves the digital representation of the individual from the immutable storage system using the digital envoy (e.g., QR code, bar code, alpha numeric code and the like). The provided facial information is compared to the facial information of the digital representation and if a match occurs, the identity is authenticated.

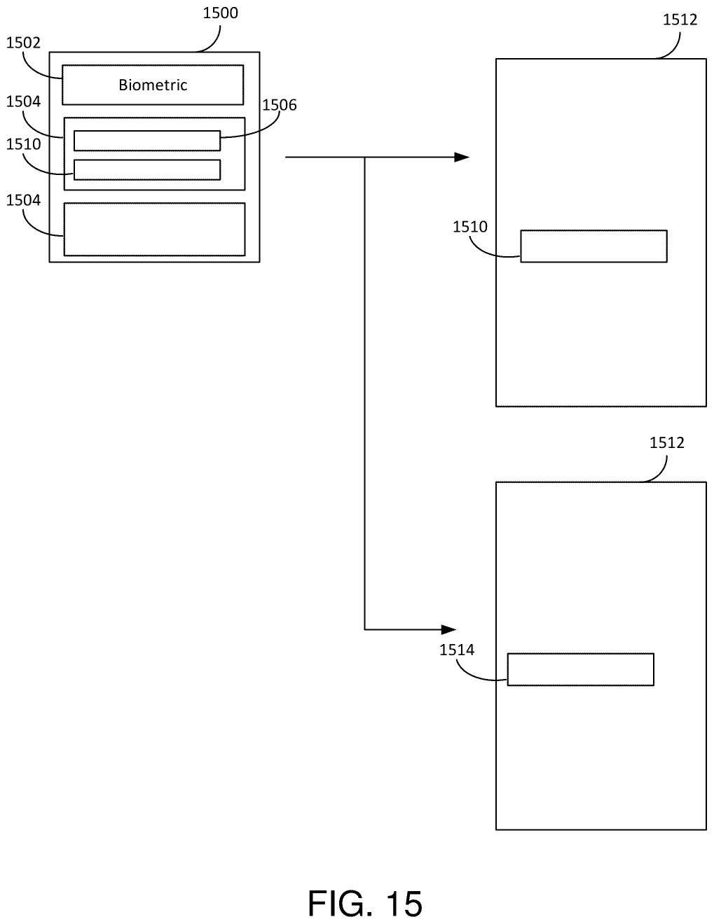

Referring to FIG. 15, in one embodiment, the individual can select what information is revealed from the digital identity record to the authentication system. The verification system can be used to create a digital identity record 1500. The digital identity record can include biometric information 1502 and personal information 1504. The personal information can include such information as name 1510, age, birthday, social security number 1506, tax identification, address and the like. The digital identity record can include metadata such as date, time and location associated with the creation of the digital record. The digital identity record can be associated with one or more events. The digital envoy 1508 can be associated with the digital identity record and used to retrieve the digital identity record from an immutable storage system or other secure system. Additional information 1508 can be in or associated with the digital identity record such as of diploma information, memberships, associations, voting information, license information, certification information, compliance information, background check, financial status, citizenship, permits, authorizations, authority, vital records, and any combination thereof.

When an individual wishes to present the digital envoy or biometric information for authentication, the user can select all or a portion of the information in or associated with the digital identity record. The presenting individual can select the information subset to be authenticated or revealed. For example, the presenting individual can select the name 1510 of the individual to be revealed when the authentication system 1512 retrieves the digital identity record. In another example the presenting individual can select the only authenticate the name of the individual without necessarily having the reveal the name itself. In this case, the authentication system can report a binary response 1514 such as match and not matched.

Referring to FIG. 2, creation of an entity creation envoy is shown. In at least one embodiment, the system includes a first capture device 200, and entity request system 204 an issuing system 206, an identity verification system 208, a formation authority system 212, a second capture device 214, an entity recordation system 220 and an immutable data storage system 218. While these systems are shown and described as separate systems, a device could store, access and/or operate more than one system. For example, a single device or system could store, access and/or operate the capture device, the entity request system and the issuing system. Similarly, a single device or system could store, access and/or operate the identity verification system and the formation authority system

By way of a non-limiting example, the entity request system could comprise a mobile or computing device associated with the entity organizer who is requesting formation of the entity. This computing device could include or be in communications with a capture device such as a scanner, camera or the like that is capable of capturing the organizer's biometric information, such as a facial image, finger prints or the like. The issuing system could comprise a mobile or computing device associated with an attorney who is responsible for submitting the organizer's entity formation request, along with any supporting documentation or information to a formation authority system associated with a person, group or organization that is responsible for forming the type of entity described in the organizer's entity formation request. One such example is the system maintained and/or operated by a Secretary of State's office. However, where no attorney is involved in the creation process and the entity organizer is submitting the entity formation request to the formation authority system, the mobile or computing device associated with the entity organizer store, access, operate and/or function as both the entity request system as well as the issuing system.

As mentioned above, the formation authority system could be one or more computing devices and/or databases that are maintained and/or operated by a governmental agency such as a Secretary of State's office, for the purpose of creating entities and/or storing entity formation information associated with such created entities. In other examples, however, the formation authority system could be one or more computing devices and/or databases maintained and/or operated by a social media platform for the purpose of creating and/or hosting social media groups.

The recordation system could be a system associated with any entity responsible for storing and/or maintaining information associated with created entities. Such a system could include a database, a data storage device, a data storage system, a data storage platform, one or more computing or mobile devices in communications with one another. The recordation system could be part of or separate from the formation authority system.

The identity verification system could be one or more computing devices and/or databases that are maintained and/or operated by an identification issuing and/or verification entity such as the Department of Motor Vehicles that is responsible for issuing drivers licenses or the Department of State that is responsible for issuing passports. However, the identification issuing and/or verification entity need not be a governmental agency.

In some cases, the system maintained by the person, group or organization responsible for creation of the entity may also include the identity verification such that a single computing device may store, access, operate and/or function as both the formation authority system and the identity verification system. This example is to provide context only and is not meant to limit or otherwise define the components, devices and/or systems of the present invention.

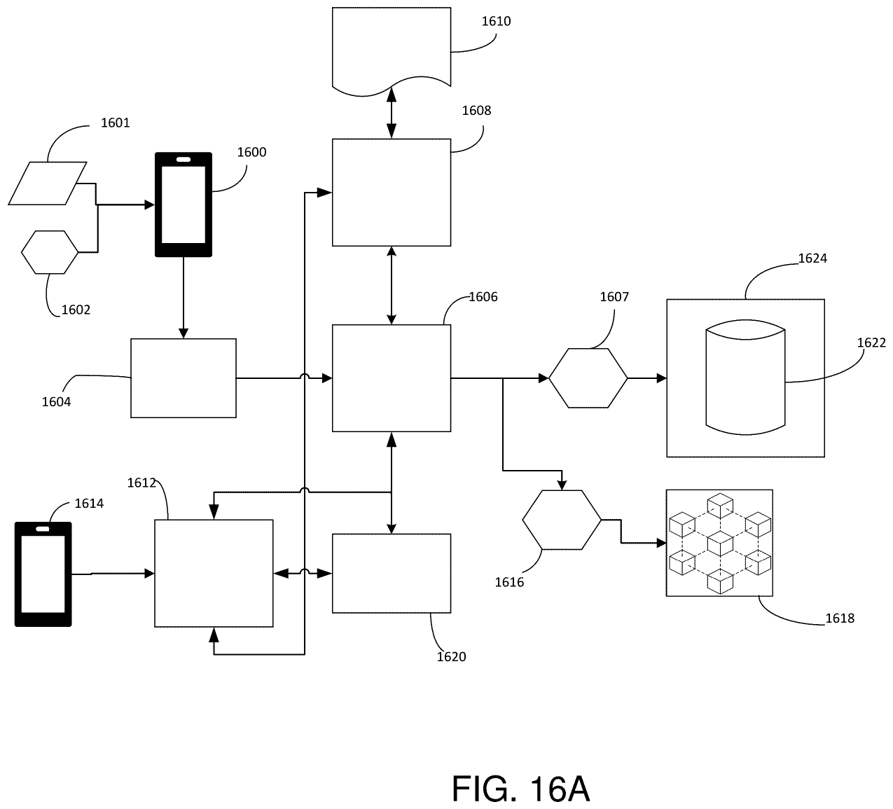

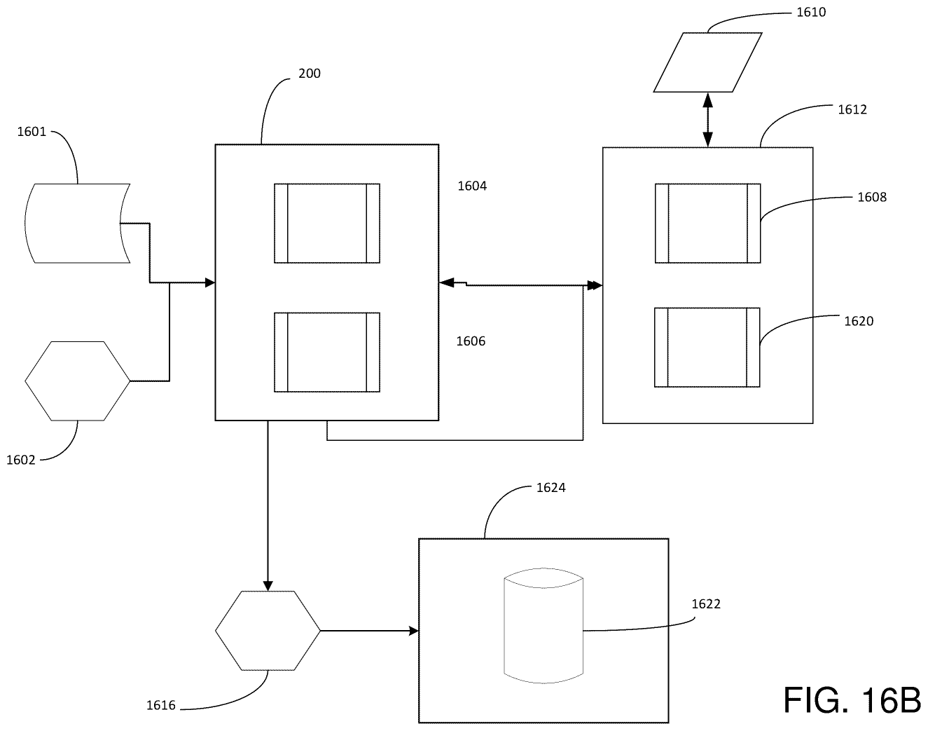

As can be seen in FIG. 16, a capture device 1600 can be in communications with an entity request system 1604. In one embodiment the capture device can be a specific computing device designed to capture biometric data, location data, date, time and other input. The capture device can include a camera, fingerprint reader, DNA reader and other biometric capture device(s). The capture device may be capable of capturing facial images, document images, and physical identification and/or location information. The capture device may also be capable of capturing location information regarding the physical location at which the organizer's biometric information was captured as well as temporal information regarding the time at which the organizer's biometric information was captured. The location information may be GPS location, weather, topography, or any other information that may reveal or assist in revealing the location at which the biometric information as captured. The temporal information may include the time at which the biometric information was captured as well as an expiration time, representing the time at which the biometric information should not be used to verify the identity of the organizer and/or to create a digital representation of an entity that is associated with the organizer. In one embodiment, the entity request system can be a computer, a mobile device, a network of computers or computing devices in communication with one another or any combination thereof. The capture device may be integral with one or more of the devices in the entity request system or may alternatively be in electronic communications, either wired or wirelessly, with the entity request system. The capture device can transmit to the entity request system 204 the information captured by the capture device, such as the organizer's biometric information. The entity request system 1604 may be associated with the entity organizer, or any person or machine or system acting on behalf of the entity to be formed. An organizer or entity organizer may include any person(s) responsible for requesting formation of the entity, person(s) requesting an update to any of the entity formation information, the person(s) submitting to the formation authority the request to form an entity or update the entity formation information, persons with the authority to act on behalf of the entity and/or any of the following categories of persons associated with the entity: incorporators, shareholders, employees, directors, officers, representatives, agents, members or the like.

The present invention may further include an issuing system 1606 that is in communication with the entity request system 1604. In one embodiment, the issuing system is responsible for communicating with a formation authority system 1612, which is responsible for forming an entity, so that the issuing system may cause the entity to be formed by the formation authority system and provide the formation authority system the information necessary to accomplish that task. In one embodiment, prior to communicating with the formation authority system 1612, the issuing system receives from the entity request system 1604 an entity formation request that represents a request to form a verified entity. The entity formation request may include information such as the type of organization to be formed, the name of the organization to be formed, the state in which the organization is to be formed or to reside, the physical address of the entity and/or the identity or location of entity's organizer(s), and/or any other information regarding the entity.

The issuing system may also receive from the entity request system the organizer's biometric information that was captured by the capture device 1600. The issuing system may also receive organizer location information and temporal information associated with the location and time at which the organizer's biometric information was captured by the capture device. The issuing system may also receive from the entity request system, an entity organizer digital envoy 1602 that is uniquely associated with a digital identity record 1610 that is associated with an entity organizer and is stored in an identity verification system 1608. The issuing system 206 use the temporal information captured by the capture device to determine whether the expiration time has expired. If it has, the issuing system may require more recent biometric information to be captured and/or transmitted before proceeding. If, however, the expiration time has not yet expired, the issuing system 1606 may use the entity organizer digital envoy 1602 to retrieve the digital identity record 1610 for purposes of comparing the digital identity record with the organizer's biometric information that was captured by the capture device 1600.

The digital identity record 1610 may include personal identifying information such as biometric information associated with the organizer and can be stored in an immutable storage system that may be part of or in communications with the identity verification system 1608. The digital identity record can be created according to previously captured and verified biometric information associated with the organizer.

In one embodiment, the entity organizer digital envoy 1602 and/or the entity creation envoy 1616 can be a code, document, object or other item which allows the digital identity record to be retrieved. For example, the digital envoy can be an alpha-numeric, graphical, image, bar code, digital quick response code or other indicia that can be displayed on a user's device such as a mobile phone. The digital envoy can also be a RFID that can be in a card format, fob, or other footprint that can be presented for authentication. The digital envoy can be presented in a physical or virtual form such as a QR code on a physical media or a QR code on a screen. The entity organizer digital envoy 1602 can be stored, captured or accessible by the capture device 1600 so that the capture device can transmit both the organizer's biometric information and digital envoy to the entity request system 1604, which can in turn transmit the organizer's biometric information and digital envoy to the issuing system 1606.

The issuing system 1606 may also be in communication with an identity verification system 1608. The identity verification system can be a closed system that includes previously authenticated and verification identity information. For example, the identity verification system may, but need not, be a governmental verification system such as maintained by the local, state, regional, or federal government. For example, one identity verification system includes driver's license information and verification system. The identity verification system creates an identity record of an individual that can include a multistep process. First, the individual must complete a form that can include personal information such as name, date of birth, gender, place of birth, social security number, email, contact phone number, mailing address and prior names that may have been used.

In the case of a governmental verification system, this form with the personal information is then presented to a governmental facility, agency or organization. In alternate embodiments, the form is submitted to a non-governmental person, facility, agency or organization responsible for accepting, reviewing and storing such forms. The form is submitted to a verifying person associated with the identity verification system along with other documents with personal information such as birth certificate, passport, consular report of birth abroad, certificate of citizenship and the like. Proof of identification can also be provided that can include driver's license, prior or current passports, military identifications, federal, state or city government employee identification, certification of naturalization and the like. A facial image can be taken by the identity verification system and/or the verifying person associated with the identity verification system. This facial image will then be associated with the form and subsequent verified identification. This process can be used by the verification system as well.

The issuing system 1606 can transmit to the identity verification system 1608, the organizer's biometric information and the entity organizer digital envoy 202 that was captured by the capture device 1600 and received from the entity request system 1604. Upon receiving the organizer's biometric information and digital envoy, the identity verification system 208 can use the digital envoy to retrieve the digital identity record 1610 from a database or other data storage device, system or platform. The identify verification may then compare the information contained in the digital identity record to the biometric information received from the issuing system and determine if the organizer's biometric information matches the information contained in the digital identity record. In response to the comparison, the identity verification system can transmit to the issuing system identity verification information indicating whether the biometric information received from the issuing system 1606 matches the organizer's digital identity record that is stored by the identity verification system. For example, the identity verification information could be “match”, or “no match”, “verified” or “unverified” or “authenticated” “not authenticated.” Accordingly, the identity verification system may verify the identity of the entity organizer without the need for the organizer to be physically present and without the need for publicly exposing the organizer's personal information.

In one embodiment, upon receiving identity verification information indicating that the biometric information captured by the capture device 1600 matches the organizer's digital identity record 210 stored by the identity verification system 208, the issuing system 1606 may create a digital representation 1607 of the entity. In cases where the digital representation is created according to the entity formation request and the identify verification information for the entity organizer, the digital representation could include information identifying the entity that was included in the entity formation request, such as name, address, organizers and the like. The digital representation could also include the organizer's biometric information that was captured by the capture device 1600 as well as the identify verification information representing that the organizer's captured biometric information matched the organizer's digital identity record stored by the identity verification system 1608. In such an embodiment, if the identity verification information received by the issuing system 1606 indicates there was not a match between the organizer's captured biometric information and the organizer's digital identity record, the issuing system may refuse to create a digital representation for the entity or create a digital representation that includes the identity verification information indicating that there was no match between the organizer's capture biometric information and/the organizer's digital identity record.

In alternate embodiments, when the issuing system 1606 receives identity verification information indicating that the organizer's captured biometric information matches the organizer's digital identity record, the issuing system 1606 may transmit to a formation authority system 1612, the entity formation request that was received from the entity request system 1604. In such an embodiment, if the identity verification information received by the issuing system indicates there was not a match between the organizer's captured biometric information and the organizer's digital identity record, the issuing system may refuse to transmit the entity formation request to the formation authority system.

In one embodiment, the formation authority system is associated with and/or operated a governmental agency such as the Secretary of State or other agency responsible for creating legal entities. In other embodiments, the formation authority system is associated with and/or operated by a non-governmental person, group or organization that is responsible for creating the type of entity for which the entity formation request is being submitted. For example, the formation authority system may be associated with a social media platform such as Facebook or an organization such as the Boy Scouts of America.

Upon receiving the entity formation request from the issuing system 1606, the formation authority system 1612 may cause the entity to be formed and entity formation information regarding the formed entity to be recorded and/or stored within the formation authority system. In addition to or instead of recording the entity formation information within the formation authority system, the formation authority system 1612 may transmit the entity formation information to a separate recordation system 1620. In either case, the entity formation information can include, the type of entity that was formed, the date it was formed, the state in which the entity was formed, the entity's status (which could be one of the following: could be “good standing,” “dissolved,” “cancelled,” “late,” “forfeited” and/or “delinquent”), whether the entity is in compliance with all of the requirements for the entity's continued existence and/or authority to operate; the identity of the organizers; the entity's address, location and/or other contact information and/or any other information about the formed entity that third parties dealing with the formed entity would like to know, verify and/or authenticate when dealing with the formed entity.

The recordation system 1620 could be part of the formation authority system or it could be a separate system. The recordation system can also be a closed system that includes previously authenticated and verified entity formation information.

After creating, recording and/or storing the entity formation information, the formation authority system 1612 and/or the recordation system 1620 may transmit and the issuing system 206 may receive the entity formation information. In at least one embodiment, the formation authority system is capable of recording location information associated with the formation authority system, such as the physical address where such system resides or the physical address of the person, group and/or organization associated with the system. The formation authority system may also be capable of transmitting such location information to the issuing system 206 so that such location information can be included in the digital representation of the entity. In a further embodiment, the formation authority system may be capable of capturing, storing and/or accessing biometric information associated with the formation individual, who is responsible for reviewing and/or approving the entity formation request. In at least one embodiment the formation authority system includes or is in communication with a second capture device 1614 that can capture biometric information of the formation individual. In such an embodiment, the authority formation system can transmit the formation individual's biometric information to the issuing system so that such information can be included in the digital representation of the entity.

Upon receiving the entity formation information, the issuing system 206 may create a digital representation 1607 of the formed entity in accordance with the identity verification information associated with the entity's organizer as well as the entity formation information received from the formation authority system 1612 and/or the recordation system 220. The digital representation could also include the organizer's biometric information that was captured by the capture device 1600.

In one embodiment, the issuing system may compare the captured organizer location information representing the location at which the organizer's biometric information was captured by the capture device to the captured entity location information representing the location of the entity included in the entity formation request. If the comparison reveals that the captured organizer location information matches the entity location, meaning that the location at which the organizer's biometric information was captured within a predetermined distance from the captured entity location identified in the entity formation request, the issuing system may proceed to create a digital representation for the entity and include as part of the digital representation information indicating that the biometric capture location information matched the entity location information. In cases where the organizer location and the entity location do not match, the issuing system may refuse to create a digital representation of the entity or may include in the digital representation information indicated there was no match between the organizer location and the entity location.

Once the digital representation 1607 of the entity is formed, the issuing system may store the digital representation on an entity database. In at least one embodiment the entity database is an immutable storage system.

In addition to creating a digital representation of the entity, the issuing system 206 may create an entity creation envoy 1616 that is associated with and can be used to access the entity's digital representation. The issuing system may then store the entity creation envoy on an immutable storage system 218. The entity creation envoy may be adapted to allow retrieval of the digital representation from the entity database 1622 using a machine-readable representation taken from the group consisting of a bar code, a quick response code, an alpha-numeric code, radio frequency identification, a graphic and any combination thereof. In one embodiment, the entity database 1622 is stored within the immutable storage system 218, in alternate embodiments, the entity database is stored in or comprises a second immutable storage system 1624.

Referring now to FIG. 16B, non-limiting examples of how more than one system may be housed in a single computing device or may be subsystems of a larger system. For example, the capture device 1600 could be a mobile computing device that stores and/or operates the entity request system 1604 and the issuing system such that when the capturing device could capture the organizer's biometric information 1601 and digital envoy 1602 and then perform all of the functions and process of the entity request system 204 and issuing system 1606 as described in FIG. 16A above. The capture device 1600 could then transmit the entity formation request along with the organizer's biometric information and digital envoy to the identity verification system 1608, which is stored in and/or operated by the formation authority system 1612 or which alternatively itself stores and/or operates the formation authority system 1612. In the shown embodiment, the entity recording system 1620 is also stored by and/or operated by the formation authority system 1612. The combined system may then perform all the functions and processes of the identity verification system and formation system as described in FIG. 16A above.

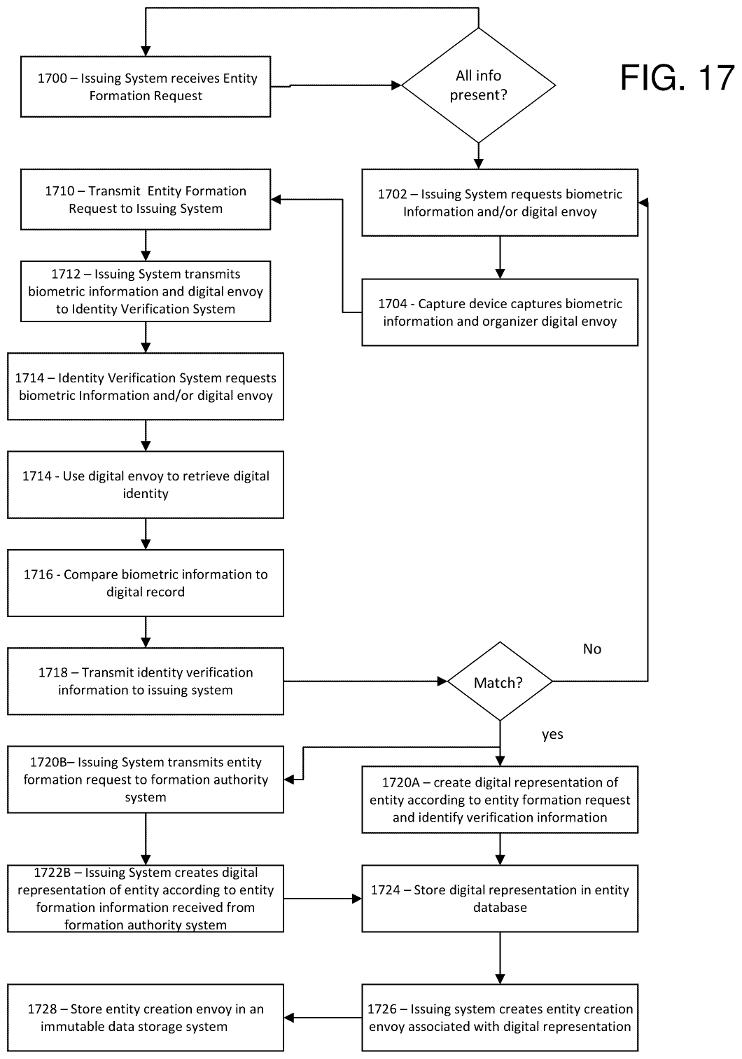

Referring now to FIG. 17, the process of creating the entity creation envoy is described. At step 1700, the entity request system receives an entity formation request. If such request is not accompanied by the entity organizer's biometric information, at step 1702, the entity request system prompts the user to provide the entity organizer's biometric information. At step 1704, the capture device captures the entity organizer's biometric information along with location information regarding the location at which such biometric information was captured. If not provided with the entity formation request or otherwise accessible, at step 1706, the entity request system prompts the user to provide the entity organizer digital envoy. At step 1708, the entity request system receives the entity organizer digital envoy. At step 1710, the entity request system transmits to the issuing system the entity formation request, the entity organizer's biometric information and the entity organizer digital envoy. At step 1712 the issuing system transmits to the identity verification system the entity organizer's biometric information and the entity organizer digital envoy. At step 1714, the identity verification system uses the entity organizer envoy to retrieve the entity organizer's digital identity, which includes biometric information associated with the organizer. At step 1716, the identity verification system compares the biometric information that was received from the issuing system to the biometric information associated with the entity organizer's digital identity. At step 1718, the identity verification system transmits to the issuing system identity verification information, indicating whether the entity organizer's biometric information and digital information matched. At step 1720, the issuing system may either (A) create a digital representation of the entity according to the entity formation request and the identity verification information or (B) transmit the entity formation request to a formation authority system. At step 1722B, the issuing system creates a digital representation of the entity according to the entity formation information received from the formation authority system. At step 1724, the issuing system stores the digital representation in an entity database. At step 1726, the issuing system creates an entity creation envoy that is associated with and may be used to access the entity's digital representation. At step 1728, the issuing system stores the entity creation envoy on an immutable storage system.

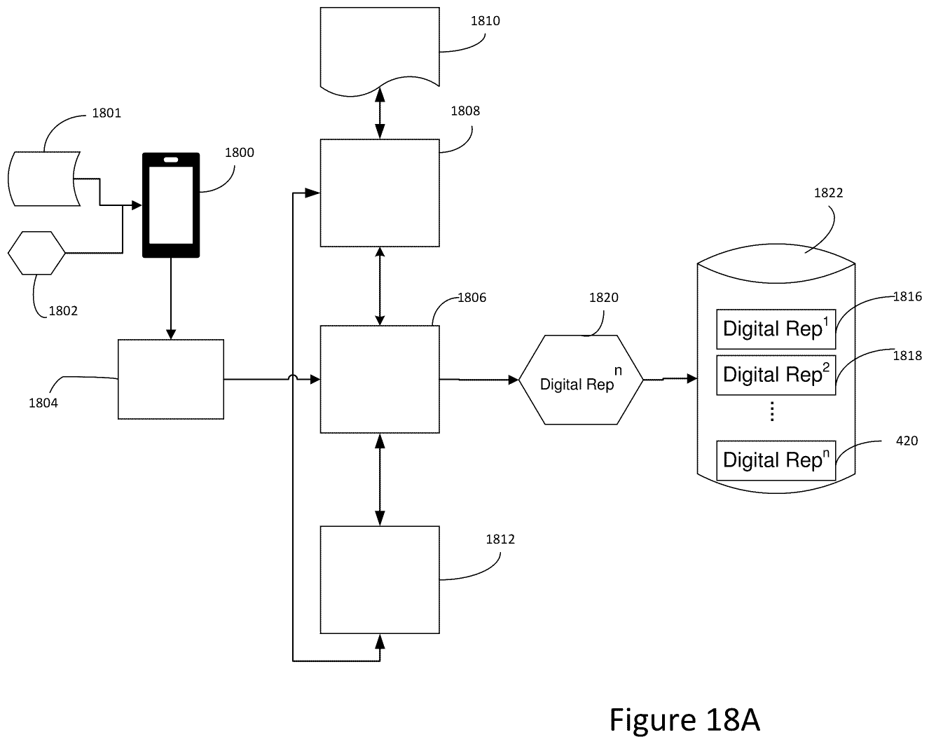

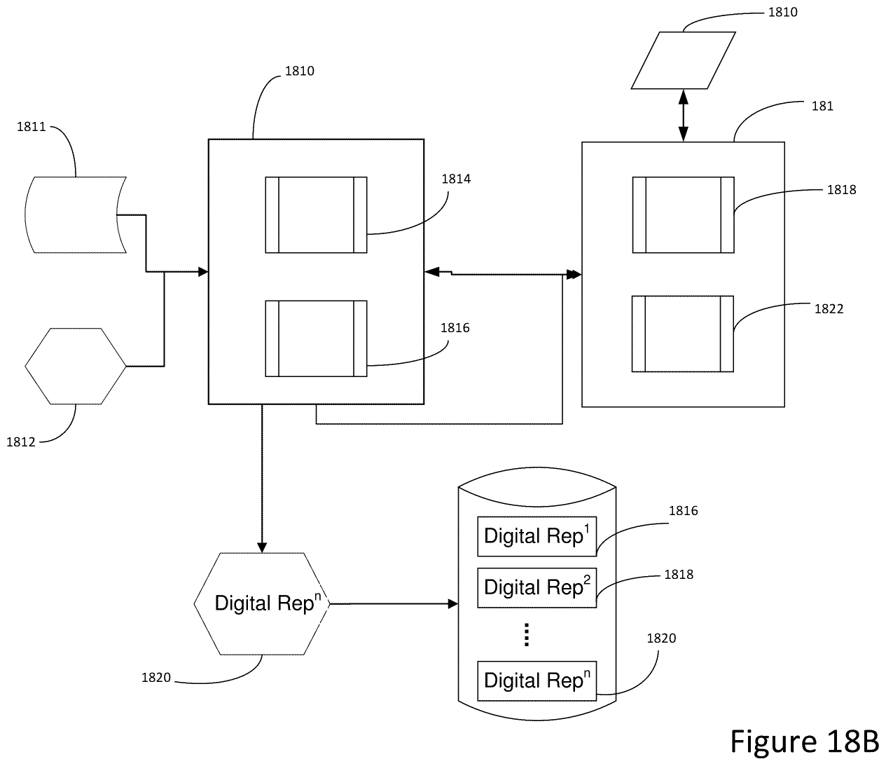

Referring now to FIG. 18A, the system and process for updating the entity's digital representation is shown. In the shown embodiment, the capture device 1800 may capture an entity organizer's biometric information 1801 and digital envoy 1802. The capture device may then transmit such information and envoy to the entity request system 1804. The entity request system may then transmit to the issuing system 1806 an entity update request along with the organizer's biometric information and digital envoy. The update request may comprise a name change, address change or entity type as well as a change in, addition to or subtraction from the list of entity organizers or a request to make a filing required by the entity formation authority and/or to maintain the entity's good standing status.

Upon receipt, the issuing system 1804 may transmit the organizer's biometric information 1801 and digital envoy 1802 to the identity verification system 1808, which will in turn use the envoy to retrieve the organizer's digital identify record 1810 and compare that record to the organizer's biometric information 1801. In much the same manner as described in association with FIGS. 2A and 2B, the verification system may send an identity verification information to the issuing system representing a either a match or an inconsistency between the organizer's biometric information 1801 and digital identity record 1810. Such an identity verification information notification could be verified for a match or unverified for an inconsistency.

Upon receiving an identity verification information representing a verification and/or a match, the issuing system 1806 may submit the entity update request to the formation authority system 1812 for processing. Once the formation authority system process and/or approves the entity update request, the authority system 1812 will send entity update information to the issuing system 1806. Such entity update information may include the entity formation information as updated by the entity update request.

Upon receiving the entity update information, the issuing system 1806 may then update the entity's digital representation according to the entity update information. One way of achieving this is the create a new digital representation of the entity according to the entity update information 1820, and to store the new digital representation in the entity database 1814 so that each digital representation DR1 (1816), DR2 (1818) through DRn (1820) may be stored within the entity database 1814. In such an embodiment, each digital representation 1,2 . . . n could be saved separately so that a timeline of changes and/or updates may be tracked and maintained for verification purposes. In such an embodiment each digital representation could be created such that each digital representation is associated with the entity creation envoy so that the entity creation envoy may be used to retrieve each digital representation or such that only the most recent digital representation (digital representation n) 1820 is retrieved by the entity creation envoy. In an alternate embodiment, the updated digital representation 1820 may simply replace the prior digital representation 1816.

Referring now to FIG. 18B, system 1824, a non-limiting example of how more than one system may be housed in a single computing device or may be subsystems of a larger system. For example, the capture device 1800 could be a mobile computing device that stores and/or operates the entity request system 1804 and the issuing system 1806 such that the capturing device could capture the organizer's biometric information 1801 and digital envoy 1802 and then perform all of the functions and process of the entity request system 1804 and issuing system 1806 as described in FIG. 18A above. The capture device 1800 could then transmit the entity update request along with the organizer's biometric information 1801 and digital envoy402 to the identity verification system 1808, which is stored in and/or operated by the formation authority system 1812 or which alternatively itself store and/or operate the formation authority system 1812. In the shown embodiment, the entity recording system 1822 is also stored by and/or operated by the formation authority system 1812. The combined system may then perform all the functions and processes of the identity verification system and formation system as described in FIG. 18A above.

Referring now to FIG. 5, the process of verifying an entity according to the entity creation envoy is described. The issuing system 504 is adapted to receive a verification request 500, which includes the entity creation envoy 502 that is associated with and may be used to retrieve the entity's digital representation 508. The verification request may seek verification of any aspect of the entity, information about which is stored in the entity's digital representation. For example, the verification request may seek verification status and/or standing with the formation authority, the identity of the organizer, the state of incorporation or the like. The entity's status with the formation authority could be one of the following: could be “good standing,” “dissolved,” “cancelled,” “late,” “forfeited” and/or “delinquent.”

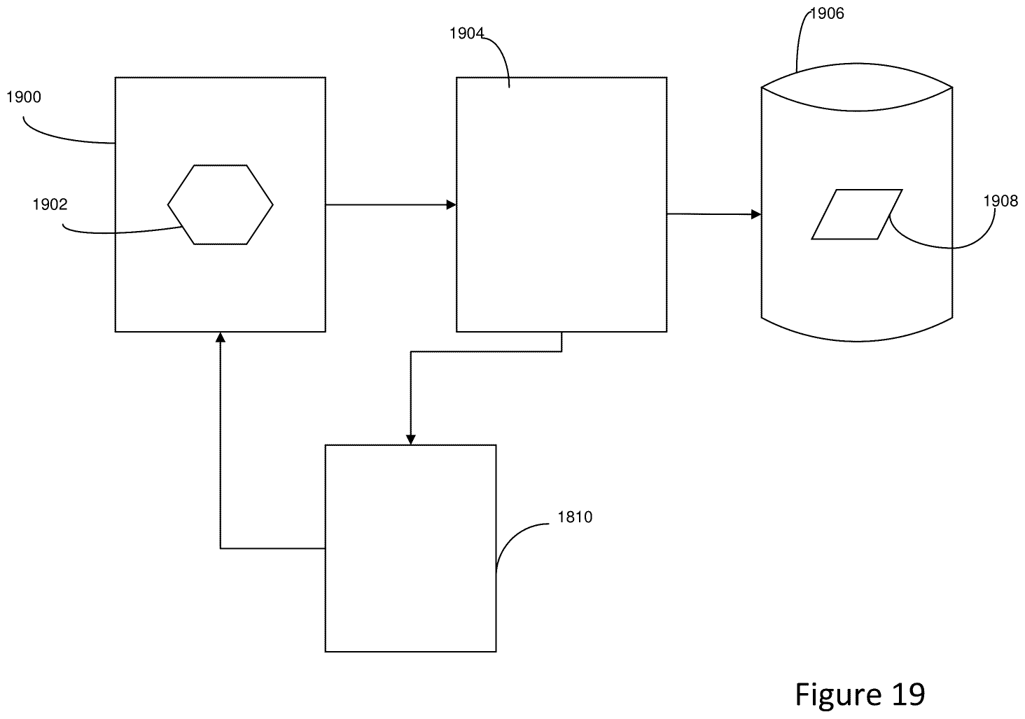

Referring to FIG. 19, upon receiving the verification request1900, the issuing system 1904 may use the entity creation envoy 1902 to retrieve the digital representation 408 from the entity database 1906. Once the digital representation is received, the issuing system can compare the entity's digital representation1908 to the information sought to be verified by the verification request (e.g., that the entity is in good standing). If the information to be verified is consistent with the information stored in the digital representation 1908, the issuing system create and transmit verification information indicating that the information is verified. If the information is not consistent, the transmitting system can create and transmit verification information indicating that the information is unverified. Examples of the type of verification information that can be submitted can be “verified” or “unverified.” When the verification request seeks verification of the entity's status the verification information transmitted could be “good standing,” “dissolved,” “cancelled,” “late,” “forfeited” and/or “delinquent.”

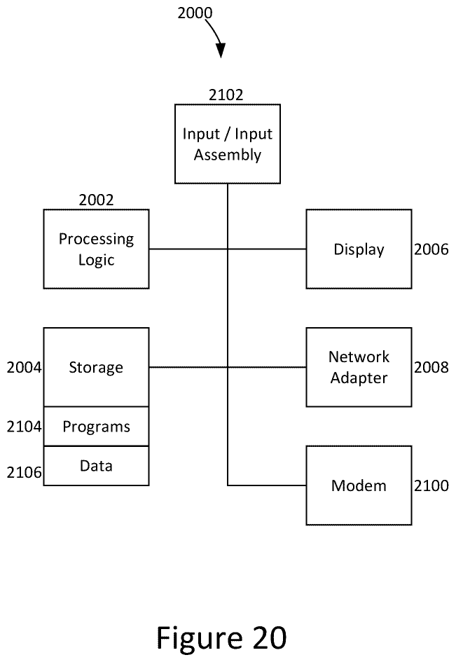

FIG. 20 shows an example of a computing device 2000 for the system. The computing system may include processing logic 2002, such as microprocessors, controllers, field programmable gate arrays (FPGA), application specific integrated circuits (ASICs) electronic circuitry, and other types of logic. The processing logic performs the operations of the computing device 2002. A storage device 2004 may also be provided. The computer readable medium and/or data storage device 2004 may take various forms, including magnetic storage, optical storage, etc. Storage capability2004 may include computer-readable media, including removable computer readable media, such as disks, thumb drives and the like, or disk drives, solid state memory, random access memory (RAM), read only memory (ROM) and other types of storage. The computing device may include a display 2006, such as an LCD display, an LED display, or other types of display devices on which video information may be displayed. The computing device 2000 may include a network adapter 2008 for interfacing with networks and a modem 2010 for communicating wirelessly, over telephone lines or cable lines with remote devices. The processing logic 2002 may use information stored in the storage device 2004. In particular, the processing logic 2002 may execute programs2014 stored in the storage and may access and store data2016 relative to the storage device 2004. The computational functionality of the system described herein may be realized by the processing logic 2002 executing the programs 2014. The system can include input or input assembly2012 that can include biometric reader, camera, microphone, scanner, sensor and the like.

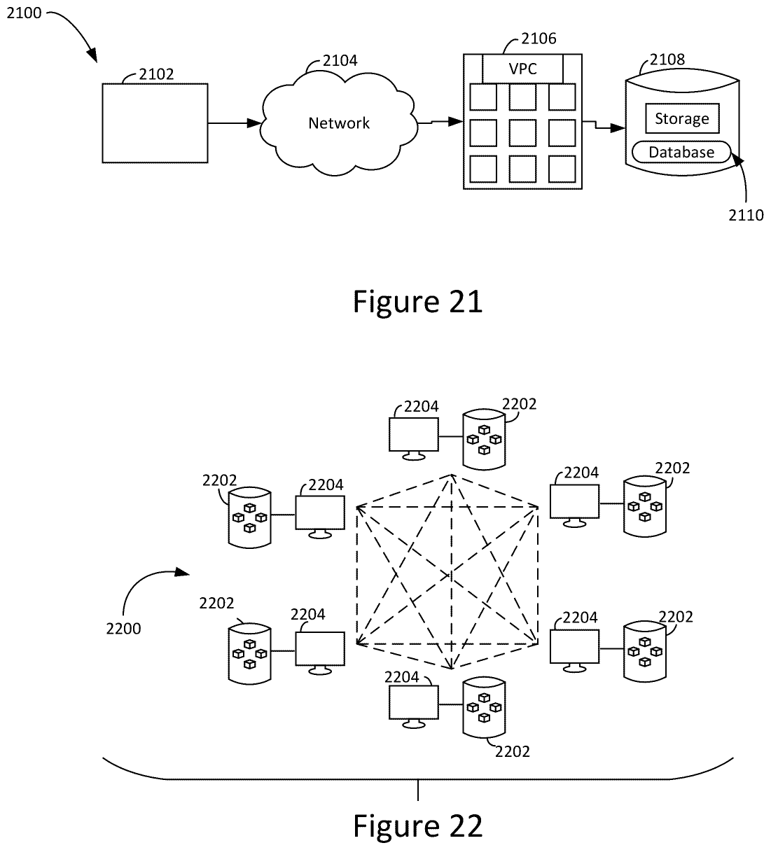

As shown in FIG. 21, the exemplary embodiments may be implemented in a decentralized computing environment 2100, that may include distributed systems and cloud computing. FIG. 21 shows one or more systems 2102 that may be in communication with a remote cluster 2106 via network 2104. System 2102 can be an entity request system, issuing system, identify verification system formation authority system, entity recording system and multiple of such systems can be in communication with an immutable storage system. Cluster 2106 may store information received from system 2102 and provide added computational functionality. The network may be a wired network or a wireless network or a combination thereof. The network 2104 may be a secure internet connection extending between the system 2102 and the cluster 2106, such as a virtual private cloud (VPC). The server may be a computing device and can be in communication with the site computer device. Cluster 2106 may include access to storage 2108. Storage 2108 may include database 2110 in which information regarding a project location is stored in a consistent manner.

FIG. 22 shows a diagram 2200 of an example of a peer-based network where an immutable storage 2202 is broadcast and shared among the nodes 2204. A node can include an entity request system, issuing system, identify verification system formation authority system, and an entity recording system. This network may be resident in the VPC cluster or in a network for example. The nodes 2204 may represent computing resources, such as server computer systems or other computing systems. Each node may have access to a copy of the immutable storage system 2202.

The various computer devices, including the server and site computer device (e.g., system, controller, and any combination), can be in communications with immutable storage system. The immutable storage system can include a distributed ledger, immutable database, block-chain structure, and the like. The communications between the various computer device, including the server and the site computer device and immutable storage can be a global communications network, wide area network, or local area network, delivered to a computer readable medium from one device to another (e.g., USB drive, CD, DVD) and can be wired or wireless.

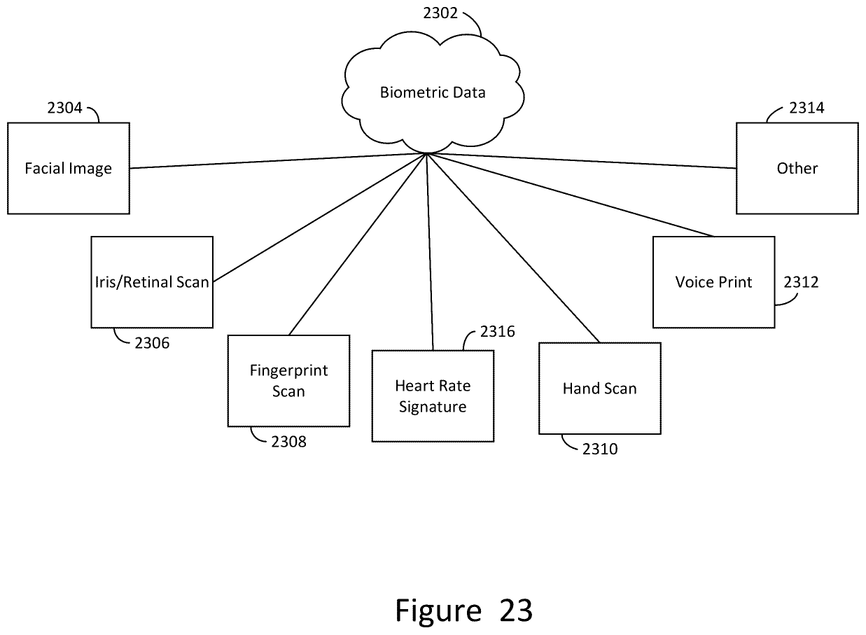

Referring to FIG. 23, biometric data 2302 that may be obtained by biometric-based identification devices at the project location to attempt to identify individuals. Biometric data may include facial recognition 2304, an iris/retinal scan 2306, a fingerprint scan 2308, a hand scan 2310, a voice print 2312, a heart rate signature 2316 or other input or sensor 2314. It should be noted that other types of biometric data may also be used in exemplary embodiments to help identify individuals uniquely. Also, an individual may be required to provide multiple types of biometric data in some instances.

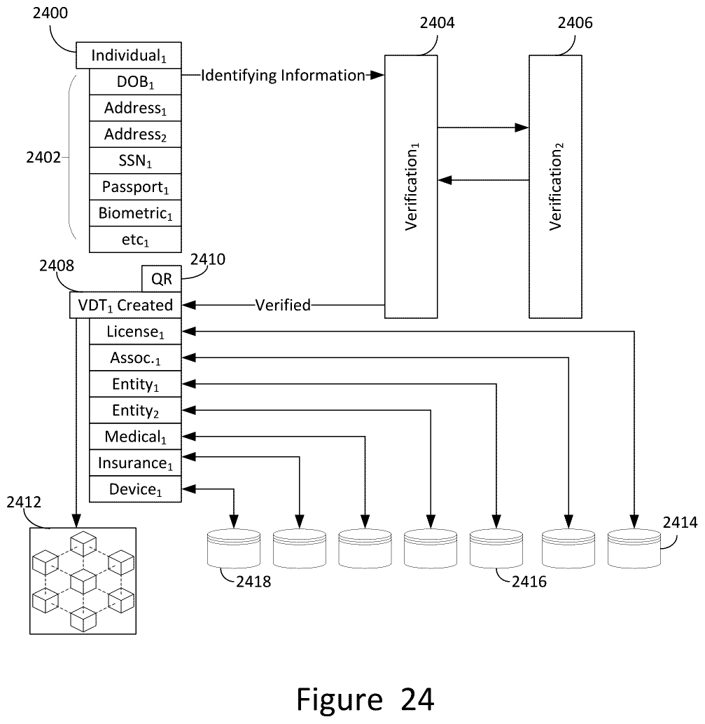

Referring to FIG. 24, the system allow for an individual (Individual1) to create the initial VDTi1-1. This process can include the individual providing identifying information 2402 associated with the individual such as date of birth, address, social security number or other governmental identification, biometric information, and the like. The system can then provide this information to a verification system 2404 that can use the information and verify that the individual and the associated identification information is accurate. The verification system 2404 can be in communication with another verification system 2406 to provide this functionality. For example, the first verification system 2404 can send certain information to the second verification system 2406 and the second verification can return if the identifying information matches preexisting records (e.g., governmental system such as passport, driver's license, identification card, and the like). If there is a match, the second verification system can return an affirmative response or a negative response as to the match. If there is an affirmative response. The first verification system can create a VDT 2408. The VDT can be stored on an immutable ledger. An envoy 2410 can be associated with the VDT so that the VDT can be retrieved by using the envoy. The envoy can be an alpha numeric indicator, bar code, RF ID and the like that can be stored on an immutable storage system 2412.

The VDT can be a digital representation or a portion of a digital representation of the individual and can include information about the individual and a link to information about the individual. The VDT can be associated with attributes, characteristics, properties and the like associated with the individual. For example, the individual can hold a license (License1) which can be included in the VDT. Also, link to licensing information can be included in the VDT that allows access to a license database 2414. Therefore, the VDT can have a smaller size for storage while providing the associated information with the individual. When the envoy (e.g., QR code) is used to retrieve the VDT, the system can retrieve the VDT from the immutable storage, retrieve the information in the VDT and if needed, retrieve information from other databases according to the information request triggering the VDT lookup.

Information that can be associated (e.g., linked) with the VDT can include trade licenses (e.g., contractor, plumber, architect, pilot, professional services, equipment operations and the like), medical information (e.g., X-rays, lab results, exams, notes, prescriptions, insurance and the like even from different sources), education information (e.g., grates, graduations, certificates, diplomas), travel information (e.g., vaccines, passports, visas). The information that can be associated with the individual can include images of captured documents such as diplomas, licenses, and other representations of achievements, qualifications, accomplishments, and the like. Further, the system can capture this additional information with a time stamp, location information, verification information and individual identification information. For example, if the additional information is a diploma, the system can capture the diploma provided by the institute, the caput relocation, the capture time and biometric information associated with the individual and presenter (e, g., student and dean). The diploma information can be in a separate VDT (e.g., VDTed1-1) linked to the individual VDT as well.

Events can also be associated with the individual such as medical encounters where the system can capture the doctor patient encounter, treatment, date and time, location, and health care provider. This can be stored in a VDT as well (e.g., VDTmed1-1).

The verification can be accomplished by the individual providing identifying information 2400 associated with that individual to a verification system 2402 (such as to the DMV). If the information is verified, the individual VDT 2404 is created and provided to the immutable storage system (blockchain) where it can be a token stored in block. The VDT is then associated with a envoy 2410. In one example, the VDT is not yet associated with additional information such as an entity. In one example, the association of the individual with the entity can be included in the initial VDT or a pointer to another database 2416 containing the association can be used. In this case the database can be immutable or not. The VDT can also include information about devices that are associated with the individual. The VDT and/or digital representation can be used to determine if the individual is associated with the device, if the device is approved for its use, and the like. The system can also track and manage devices associated with organizations and organizational VDTs. The information about the device can be associated with the VDT 2408 which can include a pointer to the device information in another database 2418.

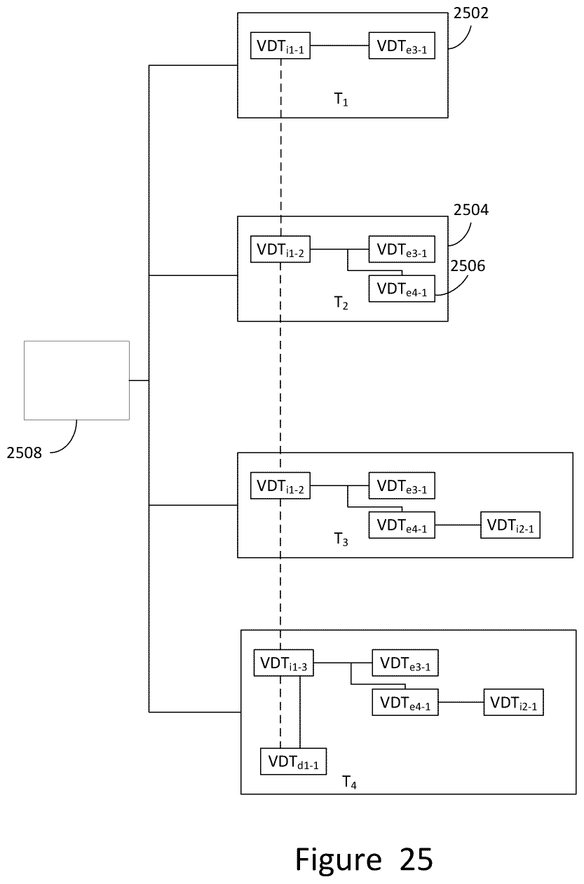

Referring to FIG. 25, the process to create, link and modify information associated with individuals and companies which use immutable storage systems is shown. At time T1 2502 there can be a VDT for the individual linked (e.g., associated) with an entity. In one example, this would result in two VDT being stored on the immutable ledger and the indexing system associated with the two. At T2, 2504, the individual can enter into an association with a second entity represented by VDTe4-1. For example, the VDTe3-1 can be an employer with VDTe4-1 a trade association. When this occurs, a second VDT 2506 associated with the individual can include this second relationship. For example, three VDT can be stored on the immutable storage system and the indexing system can manage the relationships at they exist at T2.

The actual VDT can be a copy of VDTi1-1 that is retrieved, modified, and added to in order to provide VDTi1-2. Therefore, VDTi1-2 represent the association of the individual with two entities. The association can be completely represented in VDTi1-2 or can be represented with the aggregate of VDTi1-1 and VDTi1-2. Therefore, QR1 can point to VDTi1-2 which can then point to VDTi1-1 and VDTi1-2.

If another individual is associated with the entity VDTe4-1 the VDTi2-1 can be created and stored on the immutable ledger. The relationship between the various VDT at time T3 can be managed by the indexing system for time T3. At time T4, a device VDTd1-1 can be associated with individual so that the VDTi1-3 can be created and can include links to the new device VDTd1-1 as well as the prior links. In one embodiment, VDTi1-3 can link to VDTi1-2, which can link to VDTi1-1 so that the aggregate represents the relationship relationships between the various VDTs which can be managed by the indexing system 2508. The indexing system can manage the transaction creations, writing and VDT that can be stored on an immutable ledger. The transaction system can provide for links between the VDT so that the aggregate of the VDT provides for the relationships between them.

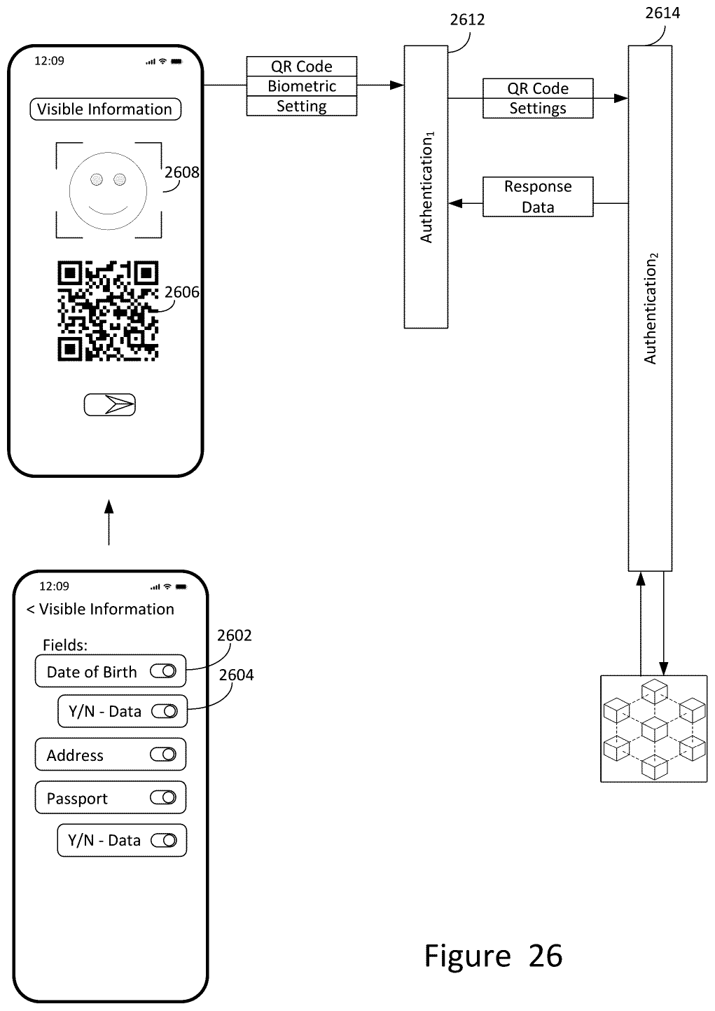

Referring to FIG. 26, the user (e.g., owner of the digital representation associated with the envoy and the VDT, can select which information to be provided to a requesting party. For example, the user can allow the requesting part to view the user's birth date with selection 2602. The user can also select for the information to only be presented as an AFFIRM or DENIED information repose at 2604. For example, if there is a age restricted transaction between the individual and vendor, the vendor can request information about the individual to insure that the individual is of a sufficient age. The user can allow the vendor to see the actual birthdate or can provide for the vendor to supply a minimal age and the system returns AFFIRM if the age is sufficient and DENY if it is not. Therefore, the vendor does not need access to the underlying data of the individual.

The individual can present an envoy 2606 (e.g., QR) and captured biometric information 2608 and transmit the information to an authenticating system 2610 (e.g., a vendor system) using button 2612. The authenticating system can response to the requested information directly or through a second authentication system 2614. In one embodiment the second authentication system can be the indexing system. This allows the holder of the QR to permit or prevent information from being shared. The system can retrieve the relevant VDT (e.g., VDTi1-2, VDTi1-1, VDTi1-2 or any combination) and present the information to the requesting individual without necessarily revealing all the information associated with the individual.

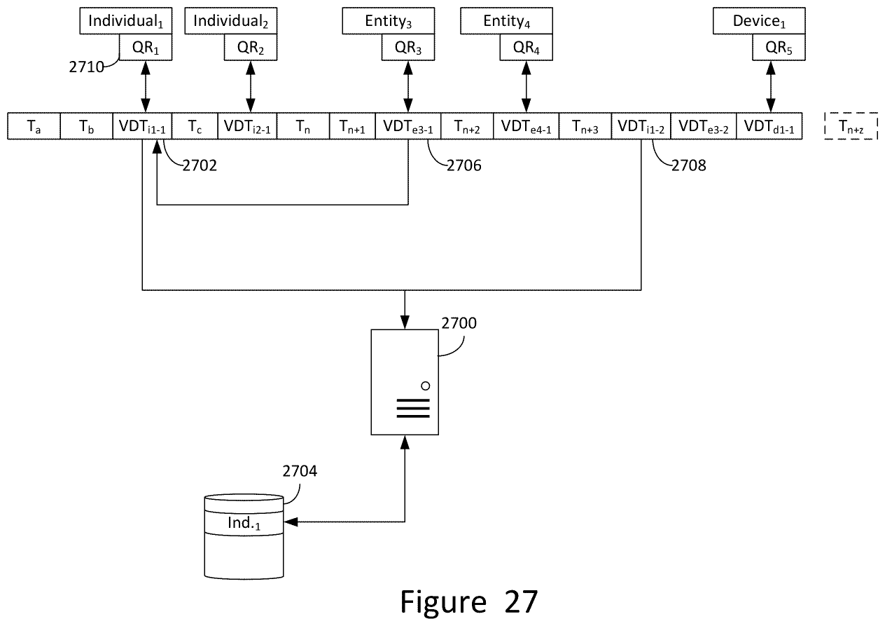

Referring to FIG. 27, the system can include an indexing system 2700 that can manage the relationships of the various VDTs with the immutable storage. The indexing system receives, storage and manages the relationship between the individual, the entities and when additional VDTs are created (e.g., when information in a VDT needs to be updated). The VDT can be amended by either writing the entire new VDT to the immutable storage system or writing a change transaction associated with the VDT to the immutable storage system. This indexing system can track the association between the multiple VDTs so that when an individual is associated with an entity, the association (e.g., relationship) can be managed by system 2700. When the initial VDTi1-1 (employee) is created and stored it can be provided to the indexing system. Therefore, when an envoy is presented to the indexing system, the indexing system can retrieve the first VDT 2702 from the immutable storage. Once retrieved, the VDT can include the requested information, or the system can use information in the VDT to retrieve further information from a database 2704. IF information associated with the individual needs to be modified, a second VDT 206 can be created and stored in the immutable storage system.

If a change is needed, a second VDT can be created stored on the immutable storage. The indexing system, when presented with an envoy, can retrieve the information associated with the VDT (i.e., its envoy) and provide it to the request system. The indexing system can also use the information in the VDT (e.g., VDTi1-1) and retrieve additional information, such as the individual employer. (e.g., VDTe3-1). In one example entity information 2708 (e.g., employer) can be linked to the individual. As modifications or new individual, devices, organizations or relationship are detailed, VDTs can be created and added to the immutable storage system.

In one embodiment, the verification system can determine a confidence score that is associated with the digital identity record. For example, if the verification system is a governmental system, the confidence score can be higher than if the verification system is self-authentication system. The authentication system can also report a confidence value with the authentication approval. For example, if the biometric image captured by the authentication system is a partial match to the biometric information in the digital identity record, the confidence value associated with the authentication system response can be lower than if the biometric image captured by the authentication system is a complete match.

Information that can be included in the process user location, object location and event location. The information can also include task, event, activity, occupants, attendees, origination, destination, pick time, delivery time, and other information concerning the object. The user can verify that the object matches the digital representation of the retrieved record. If the object is verified, the user can physically capture the event, for example, by affixing its indicia to the object representing this verification. A system can create a record that can be stored on the immutable storage system. Verification and authentication can be provided using the metadata of the various events. For example, if the date, time, and location of the individual, object and event record is within a certain range of values of the date, time and location of the pickup event, there will be verification and authentication that the proper individual or object was acted upon (e.g., transported) for example.

One verification and authentication can be the comparison of an image of the individual taken at the first event and the image of the physical object taken at the second event. In one embodiment, the determination if the two images represent the same individual can be made by comparison the distance between the images. The distance between the images of the two captures do not have to be identical but can be defined by the “closeness” between the images. In one embodiment, the distance can be used as the Euclidean distance between the I^{th} and j^{th} physical object. Distance between the p-dimensional vectors can be represented as:

$${d}_{E} ( i , j ) = \sqrt{( {\sum }_{k = 1}^{p} {( {x}_{i k} - {x}_{j k} )}^{2} )} \qquad ( 1 )$$

or by using the weighted Euclidean distance that can be represented as:

$${d}_{E} ( i , j ) = \sqrt{( {\sum }_{k = 1}^{p} {{w}_{k} ( {x}_{i k} - {x}_{j k} )}^{2} )} \qquad ( 2 )$$

Where d_{E}=distance, i=first image, j=second image, and w=weight between kth measure which can be subject to the following

$$0 < {w}_{i} < 1 and {\sum }_{i = 1}^{n} 1 \qquad ( 3 )$$

Using this system, the user can be assured that an individual was independently verified and authenticated, and the digital representation is paired. The system described herein can pair the physical with a digital representation. Failure to pair the physical with the digital representation can negatively impact areas such as regulatory requirements, financial transactions, aces, travel and any number of areas. For example, regulatory requirements are a set of rules that can specify the standards for an individual and the individual's activities. Regulatory requirements impact designs, materials, worker's license and experience of the project and process. For example, a building code may require that licensed individuals perform tasks in accordance with manufacturer's specifications and warranty regulations. Failure to follow the requirements can result in the project not being approved, errors, lack of customer satisfaction, insurance claims, injury, litigation, and other negative ramifications. Tracking, management, and verification of individuals to ensure compliance with regulatory requirements and proper installation according to applicable specifications is an important aspect to many projects and processes. Tracking and record keeping during the project or process can be beneficial, as it can be difficult to perform these tasks after project or process completion because the materials can be hidden from view or otherwise inaccessible. For example, electrical wiring in a project or process can be hidden behind walls and ceilings once the project is complete.

Systems at multiple locations may be interconnected using image capture devices, RFID, QR codes, barcodes, biometric scanners, still cameras, video cameras, and the like to identify individuals or machines that are performing verifications during the process. Further, multiple individuals or machines are performing verifications so that there is not a reliance upon any one entity for verifications. The processing of capturing data, including images, from multiple systems at multiple locations can be used to improve the verification of proper materials and assemblies as well as to pair the physical items with the digital representation.

Verification and authentication of processes, inspections, completions and deliveries with adjustments and notifications (manual and automated) with confirmation would ensure increased productivity, especially if accessible in real time at the location. Real time processes and procedures planned with corresponding training and manuals would improve quality control and efficiency. This has been a long felt need in the prior art that has not been satisfied with a controller that is uniquely associated with an asset location.

Automated verification and authentication of quantities, quality, and correct product deliveries along with after delivery tracking of materials with accountability is seldom used. Designated delivery areas with geofenced control and tracking of materials once delivered would help prevent loss. Confirmation of products integrated at the asset location provides transparency regarding sourcing, warranties, as well as future reference during the structure and individual product's life of use.

By using the various tags and digital representations, each entity in the process can verify that the physical materials match any record the precedes that entity.

This process can include internal and external individuals and machines for performing inspections (e.g., verifications). For example, the system can receive a set of internal inspection information entered into the system from an internal inspector representing an internal physical inspection of the project, material or assembly. As the items travel, an internal inspector can provide inspection information representing the stages of the project. The system can also receive a set of external inspection information from an external inspector and an external inspection computer device representing a third-party physical inspection of the project at predetermined stages of the project. Based upon the internal inspection, external inspection or both, an inspection record can be created and stored on the immutable storage.

The verified pairing described herein can also be used to pair physical assets with installation instructions, storage instructions, warranties, ownership, service, maintenance, and any combination thereof.

The system can also facilitate the use of digital wallets or other digital storage technologies. The information that is contained on the digital wallet can be paired with a physical object so that transactions associated with the physical object can be conducted with verification that the digital representation in the digital wallet represents the physical object, whether the physical object is fungible or unique.

The computer system can be in communication with an immutable storage; a first computer device in communications with the computer system; a second computer device in communications with the computer system; a set of computer readable instructions included in the computer system configured for: receiving an event record from the first computer device including a first location, a first time and a first set of metadata wherein the first set of metadata includes an original digital representation captured by the first computer device of the physical object, receiving a subsequent event record from the second computer device including a second location, a second time temporally subsequent to the first time and a second set of metadata wherein the second set of metadata includes a subsequent digital representation captured by the second computer device of the physical object, and, determining if the original digital representation is equivalent to the subsequent digital representation thereby providing for verification that the same physical object transitioned from an originating event to a subsequent event.

The event record can include a verification and authentication code that can be used to verify that the data in the event record remains accurate from its creation of from another time. The verification can have several constructions including checksum. A checksum can be a small block of data, usually digital, derived from another block of digital data configured for use for detecting errors that can occur transmission, storage or unintentional or intentional tampering with the data. A first record can have a first checksum. A second record can have a second checksum. The second checksum can be derived from the first and the second record so that alteration of the first or second record can be detected with the second checksum.

Certain verifications and authentications can be a hash. A hash can be a mathematical function that is configured to converts an input, such as a data record, into an encrypted output, typically having a fixed length. Therefore, a unique hash can be the same size regardless of the size of amount of the input (e.g., data). Further, the hash can be configured to prevent reverse-engineering of the input because the hash functions is a one-way function. When analyzing a record, such as an event record, comparing a first hash that can be created and stored with the event record and a second hash calculated when the event record is retrieved can provide validation that the data is unaltered from storage to retrieval. The verification code can be the hash.

In one example, a data record is an input that is processed with computer readable instructions configured with a hashing algorithm that can include a secure hashing algorithm, message digest algorithm, Keccak, RACE integrity primitives evaluation message digest, Whirlpool, BLAKE, and the like and any combination. The output can be a first verification code and that first verification code is stored on an immutable ledger or other secure location. The hashing algorithm can be deterministic so that the input will result in the same output. The hashing algorithm can be configured to prevent the ability to see or read the data that is the original input. The hashing algorithm can be configured so that a small change, even one byte, will change the output. Therefore, the first output of the data will not match the second output if the data is changed between when the first data and the second data is determined.

The set of computer readable instructions can include instructions for determining if a similarity between the original digital representation and the subsequent digital representation is within a predetermine range. The first computer device can be remote from the computer system. The subsequent event record can include verification data representing that verification of the physical object subject to the subsequent event is the same physical object associated with the originating event according to the first event record. The set of computer readable instructions can include storing the first event record on the immutable storage and the set of computer readable instructions for determining if the first digital representation is equivalent to the subsequent digital representation includes retrieving the first event record from the immutable storage. The subsequent event record can include verification data representing that an individual viewed the metadata of the first event record and compared it with the physical object. The second set of metadata is taken from sources from the group consisting of public records, enterprise software, computer devices or any combination thereof.

The set of computer readable instructions can include instructions for determining if the individual is the same individual represented by the first digital representation during an occurrence of a second event. The subsequent event record can include verification data representing that verification of the physical object subject to the subsequent event is the same physical object associated with the first event. The subsequent event record can include verification data representing that an individual viewed the metadata of the first event record and compared it with the physical object. The first computer device can be a remote from the computer system and the second computer device.

The computer readable instructions can include instruction for determining if the similarity is within a predetermine range. The computer readable instruction can include instructions for determining if a similarity between the first digital representation and the second digital representation exists includes retrieving the first event record from the immutable storage. The subsequent event record includes verification data representing that verification of the physical object subject to the subsequent event is the same physical object associated with the first event according to the first event record. The computer device can be a first computer device; and the computer readable instruction can include instructions for determining if a similarity between the first digital representation and the second digital representation exists includes retrieving a first image of the physical object, comparing the image to a second image captured by a second computer device and determining if the images represent the same physical object. The instructions can determine if a similarity between the first digital representation and the second digital representation exists includes capturing an object indicium affixed to the physical object, comparing the indicium on the object at the subsequent event to a digital indicium included in the first event record. The subsequent event record can include verification data representing that an individual viewed the object indicium and compared it with the digital indicium retrieved from the immutable storage and included in the first event record.

In one embodiment, the system can provide a hashed event record where the event record can include metadata associated with a capture device as well as indicium associated with the physical object and store the record on a blockchain platform including the platforms associated with Bitcoin, Ethereum and the like.

What is claimed is:

1. A system for creating and storing a digital identity associated with an individual having limited information publication comprising:
a first capture device adapted to capture biometric information, alpha numeric information and graphical information;
an immutable storage system adapted to store a verified digital token (VDT) associated with the individual,
a generation server adapted to generate the VDT from an individual envoy representing a digital representation of an individual data captured from the first capture device and wherein the VDT is verified from a verification system;
a second capture device adapted to capture a biometric information, retrieve the VDT according to the biometric information and publish credential data included in the VDT.

2. The system of claim 1 wherein the second capture device adapted to publish an age of the individual associated with the VDT according to the VDT.

3. The system of claim 1 wherein the second capture device is adapted to publish an affirmation that the individual is of a predetermined age according to the VDT wherein an age of individual is associated with the VDT.

4. The system of claim 1 wherein the verification system is adapted to: receive a first biometric information from the first capture device, receive a digital envoy from the first capture device, transmit the first biometric information and the digital envoy to the verification system, and determine that the VDT is verified.

5. The system of claim 1 wherein the VDT is generated according to an organizational envoy representing a digital representation of an organization associated with the individual.

6. The system of claim 1 including an indexing server adapted to store a relationship between an individual digital representation and an organization representation.

7. The system of claim 1 wherein the verification system is taken from the group consisting of a government verification system, a witness verification system, an organization verification system, an aggregate of one or more events, a self-verification system, an in-person verification system and any combination thereof.

8. The system of claim 1 wherein the second capture device is an autonomous computing system.

9. The system of claim 1 wherein the generation server is adapted to create a confident value associated with the VDT and according to the verification system.

10. The system of claim 1 wherein the generation server is adapted to create a confident value associated with the VDT and according to a comparison of a location, a time, an object, an event, and any combination thereof associated with the individual.

11. The system of claim 1 wherein the individual envoy is stored in a digital wallet associated with the individual.

12. The system of claim 1 wherein the credential data is represented by a binary response.

13. The system of claim 12 wherein the credential data is represented by a binary response such as PASS and FAIL.

14. The system of claim 1 wherein the VDT is taken from the group consisting of a computer readable code, an alpha numeric code, a bar code, a quick response code and any combination thereof.

15. The system of claim 1 wherein a relationship between the individual and an organization is stored on the immutable storage system with the VDT.

16. The system of claim 1 wherein the VDT includes information about authorization and authorized uses.

17. A system for creating and storing a digital identity associated with an individual having limited information publication comprising:
a verified digital token (VDT) associated with the individual and stored on an immutable ledger wherein the VDT is verified from a verification system;
a capture device adapted to capture a biometric information, retrieve the VDT from the immutable ledger according to the biometric information and publish a portion of the data included in the VDT.

18. The system of claim 17 wherein the portion of the data included in the VDT is an age of the individual.

19. A system for creating and storing a digital identity associated with an individual having limited information publication comprising:
a verified digital token (VDT) associated with the individual and stored on an immutable ledger wherein the VDT is verified from a verification system;
a capture device adapted to capture a biometric information, retrieve the VDT from the immutable ledger according to the biometric information and publish a response according to the data included in the VDT.

20. The system of claim 19 wherein the response according to the data included in the VDT is represented by a binary response such as PASS and FAIL.

21. The system of claim 20 wherein PASS represents that the individual is older than a predetermined age.
